(19) United States
(12) Patent Application Publication
(10) Pub. No.: US 2023/0361895 A1
(43) Pub. Date: Nov. 9, 2023

(54) ENHANCED INTER-USER-EQUIPMENT SUB-BAND CROSS LINK INTERFERENCE REPORT

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Yan ZHOU, San Diego, CA (US); Tao LUO, San Diego, CA (US)

(21) Appl. No.: 18/311,855

(22) Filed: May 3, 2023

Related U.S. Application Data
(60) Provisional application No. 63/364,415, filed on May 9, 2022.

(51) Int. Cl. H04B 17/345

(52) U.S. Cl. CPC H04B 17/345

(57) ABSTRACT

An apparatus may be configured to measure a CLI metric for each of a plurality of DL sub-bands configured for the apparatus and to transmit information relating to the CLI metric for a subset of the plurality of DL sub-bands and/or to transmit a single-bit indication reporting the CLI metric for at least one DL sub-band in the plurality of DL sub-bands. The apparatus may be configured to configure a first set of resources for a first UE to measure a CLI metric from a second UE in each of a plurality of DL sub-bands configured for the first UE and to receive information relating to the CLI metric for a subset of the plurality of DL sub-bands and/or to receive a single-bit indication reporting the CLI metric for at least one DL sub-band in the plurality of DL sub-bands.

### CROSS REFERENCE TO RELATED APPLICATION(S)

This application claims the benefit of and priority to U.S. Provisional Application Ser. No. 63/364,415, entitled “Enhanced Inter-User Equipment Sub-band Cross Link Interference Report” and filed on May 9, 2022, which is expressly incorporated by reference herein in its entirety.

### TECHNICAL FIELD

The present disclosure relates generally to communication systems, and more particularly, to wireless communication including cross link interference (CLI) reporting.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to measure a CLI metric for each of a plurality of downlink (DL) sub-bands configured for a first user equipment (UE), the CLI metric measuring interference to DL reception at the first UE due to an uplink (UL) transmission from a second UE and to transmit information relating to the CLI metric for a subset of the plurality of DL sub-bands.

In an aspect of the disclosure, a method, a computer-readable medium, and an apparatus are provided. The apparatus may be configured to measure a CLI metric for each of a plurality of DL sub-bands configured for the first UE, the CLI metric measuring interference to DL reception at the first UE due to an UL transmission from a second UE and to transmit a single-bit indication reporting the CLI metric for at least one DL sub-band in the plurality of DL sub-bands.

In an aspect of the disclosure, a method, a computer-readable medium, and an apparatus are provided. The apparatus may be configured to configure a first set of resources for a first UE to measure a CLI metric in each of a plurality of DL sub-bands configured for the first UE, the CLI metric measuring interference to DL reception at the first UE due to an UL transmission from a second UE and to receive information relating to the CLI metric for a subset of the plurality of DL sub-bands.

In an aspect of the disclosure, a method, a computer-readable medium, and an apparatus are provided. The apparatus may be configured to configure a first set of resources for a first UE to measure a CLI metric in each of a plurality of DL sub-bands configured for the first UE, the CLI metric measuring interference to DL reception at the first UE due to an UL transmission from a second UE and to receive a single-bit indication reporting the CLI metric for at least one DL sub-band in the plurality of DL sub-bands.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a diagram illustrating a communication system associated with various modes of duplexed communications, such as full-duplex communication and time-duplexed communication.

FIG. 5A is a diagram illustrating a first example of a resource allocation for (fully-overlapping) in-band full-duplex (IBFD) communication.

FIG. 5B is a second diagram illustrating a second example of a resource allocation for (partially-overlapping) in-band full-duplex communication.

FIG. 5C is a third diagram illustrating a third example of a resource allocation for sub-band full-duplex (SBFD) communication.

FIG. 5D is a fourth diagram illustrating a fourth example of a resource allocation for flexible, or dynamic, time division duplexed (TDD) communication.

FIG. 6 includes a diagram illustrating various modes of duplexed communications, such as full-duplex communication and time-duplexed communication, between a first base station and a first UE and/or a second base station and one or more of a second UE and/or a third UE.

FIG. 7 includes a call flow diagram of a method of wireless communication between two network nodes in accordance with some aspects of the disclosure.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an apparatus.

FIG. 17 is a diagram illustrating an example of a hardware implementation for a network entity.

### DETAILED DESCRIPTION

In some aspects of wireless communication, the ability to perform CLI measurements for each of a plurality of sub-bands may provide additional information that allows for better resource allocation between UL and DL resources (or better allocation of UL/DL resources among transmissions of different priorities). However, the sub-band reporting of CLI, in some aspects, increases signaling overhead. Accordingly, a method and apparatus for reducing the overhead associated with sub-band CLI reporting is presented. For example, the reported sub-band CLIs may be limited to those that are above a configured CLI threshold value or a single bit for each sub-band may be added to indicate whether the sub-band is experiencing CLI above (or below) a threshold instead of a multi-bit indication of a CLI metric value. In some aspects, the method and apparatus presented herein provide some of the benefits of per-sub-band CLI reporting while reducing the overhead costs of per-sub-band CLI reporting.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

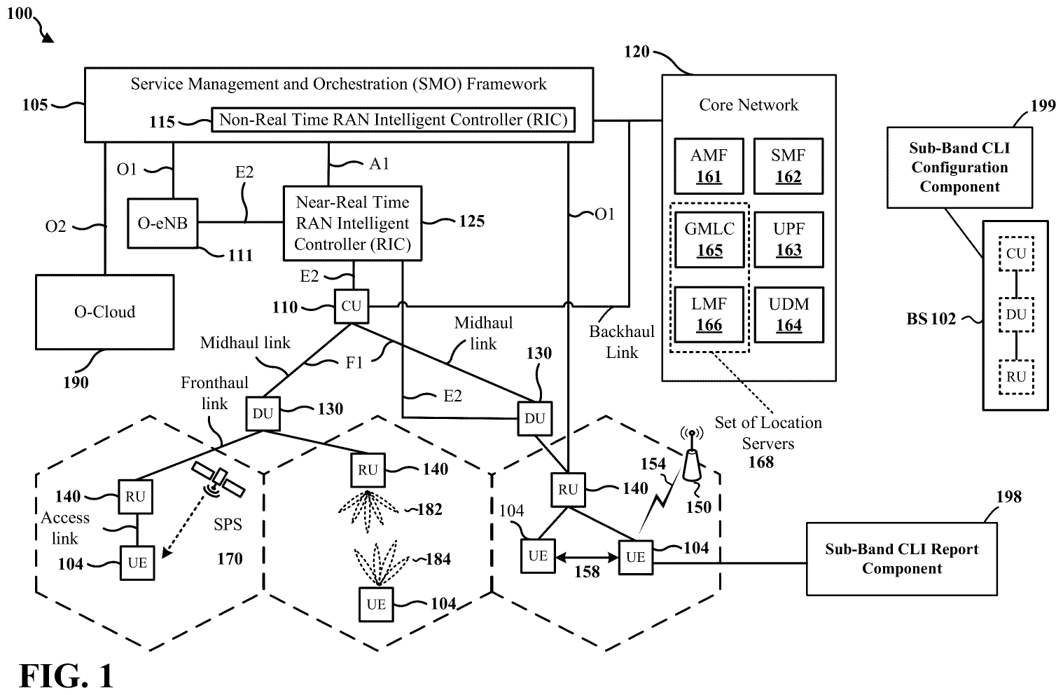

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a sub-band CLI report component 198 configured to measure a CLI metric for each of a plurality of DL sub-bands configured for the first UE, the CLI metric measuring interference to DL reception at the first UE due to an UL transmission from a second UE. The sub-band CLI report component 198 may further be configured to transmit information relating to the CLI metric for a subset of the plurality of DL sub-bands and/or to transmit a single-bit indication reporting the CLI metric for at least one DL sub-band in the plurality of DL sub-bands. In certain aspects, the base station 102 may include a sub-band CLI configuration component 199 configured to configure a first set of resources for a first UE to measure a CLI metric in each of a plurality of DL sub-bands configured for the first UE, the CLI metric measuring interference to DL reception at the first UE due to an UL transmission from a second UE. The sub-band CLI configuration component 199 may further be configured to receive information relating to the CLI metric for a subset of the plurality of DL sub-bands and/or to receive a single-bit indication reporting the CLI metric for at least one DL sub-band in the plurality of DL sub-bands. Although the following description may be focused on 5G NR, the concepts described herein may be applicable to other similar areas, such as LTE, LTE-A, CDMA, GSM, and other wireless technologies.

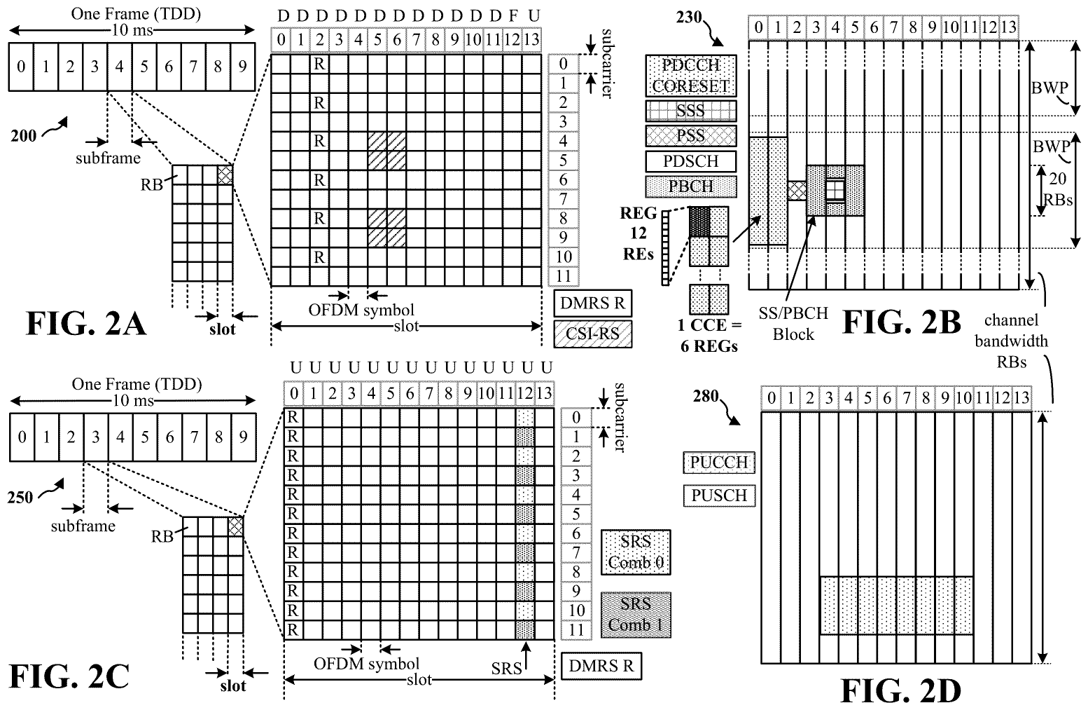

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

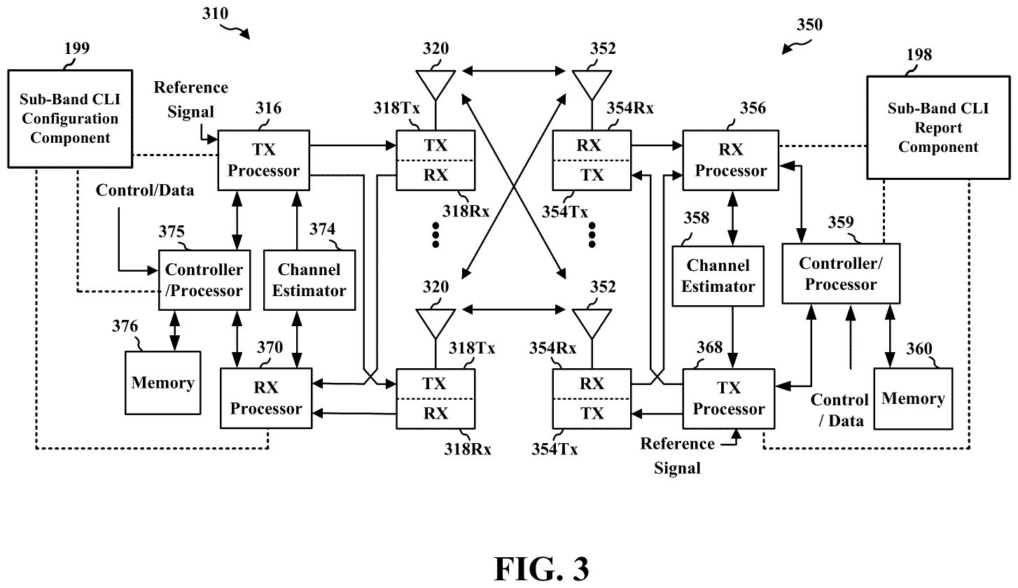

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sub-band CLI report component 198 of FIG. 1.

At least one of the TX processor 316, the RX processor 370, and the controller/processor 375 may be configured to perform aspects in connection with the sub-band CLI configuration component 199 of FIG. 1.

Wireless communication systems may be configured to share available system resources and provide various telecommunication services (e.g., telephony, video, data, messaging, broadcasts, etc.) based on multiple-access technologies that support communication with multiple users.

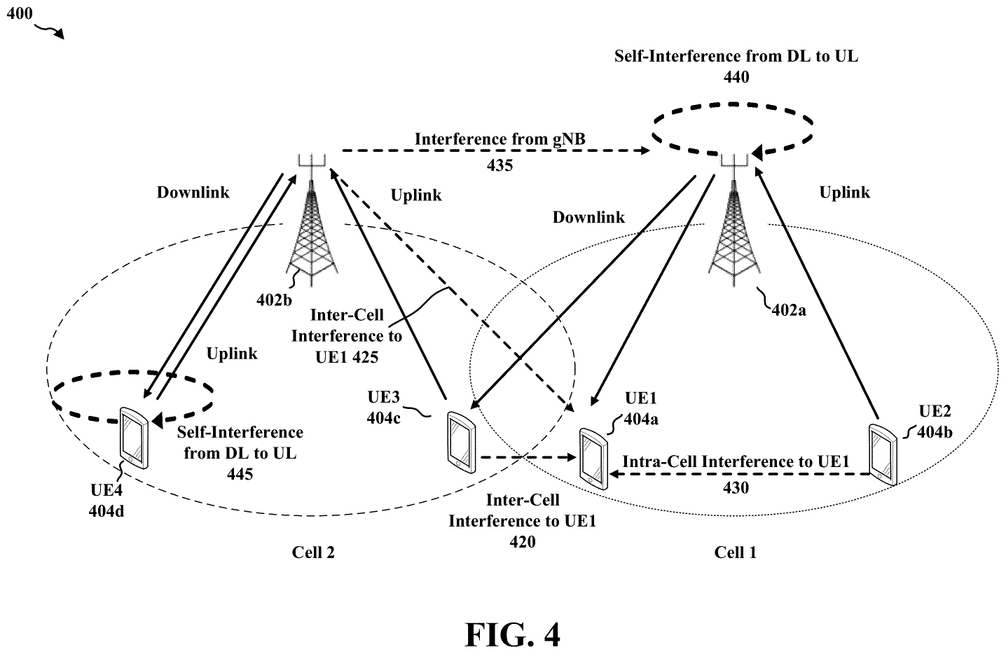

FIG. 4 is a diagram 400 illustrating a communication system associated with various modes of duplexed communications, such as full-duplex communication and time-duplexed communication. Full-duplex communication supports transmission and reception of information over a same frequency band in manner that overlap in time. In this manner, spectral efficiency may be improved with respect to the spectral efficiency of half-duplex communication, which supports transmission or reception of information in one direction at a time without overlapping uplink and downlink communication. The full-duplex communication may reduce latency in communication by allowing transmission to occur while reception is being performed or allowing reception while transmission is being performed, e.g., such as enabling the reception of downlink signals in uplink slots. In some aspects, full-duplex communication may improve spectrum efficiency, e.g., per cell or per UE. Full-duplex communication may provide efficient resource utilization and may allow for coverage improvements. Due to the simultaneous Tx/Rx nature of full-duplex communication, a UE or a base station may experience self-interference caused by signal leakage from its local transmitter to its local receiver, e.g., in which a signal transmitted by the UE or base station is received as interference to its reception of another signal. In addition, the UE or base station may also experience interference from other devices, such as transmissions from a second UE or a second base station. Such interference (e.g., self-interference or interference caused by other devices) may impact the quality of the communication, or even lead to a loss of information. Time-duplexed communication supports transmission and reception of information over a same frequency band in a manner that does not overlap in time. Due to transmission delay a UE or base station may experience interference from other devices caused by time delays associated with transmissions received from the other devices.

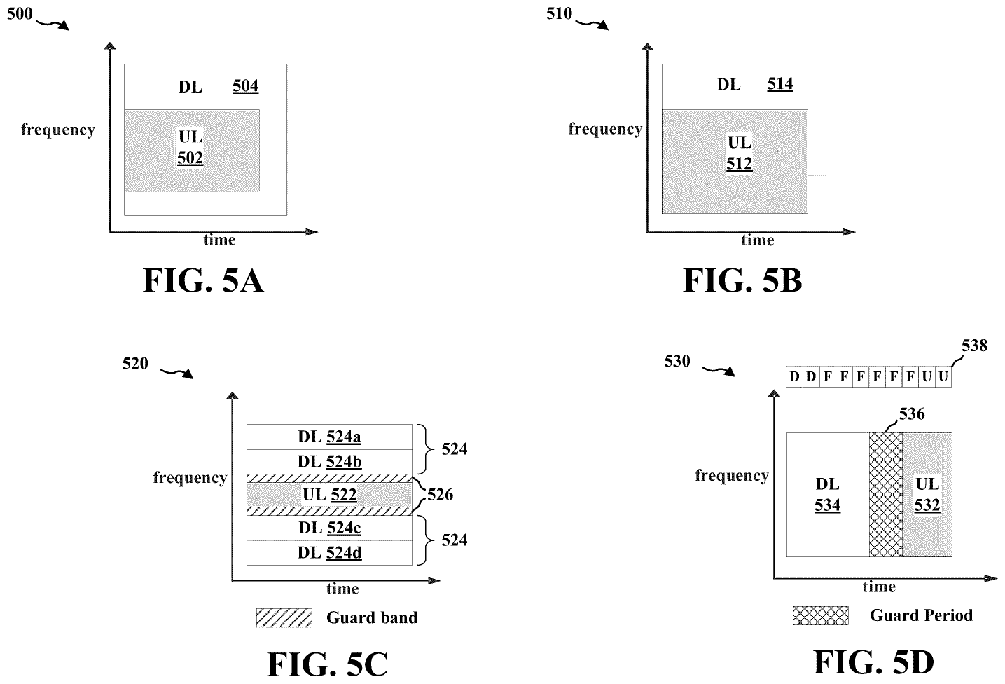

FIG. 5A is a first diagram 500 illustrating a first example of a resource allocation for (fully-overlapping) in-band full-duplex (IBFD) communication. The resource allocation for IBFD communication may include a first set of UL resources 502 and a second set of DL resources 504. As shown in the first diagram 500, a time and a frequency allocation of the first set of UL resources 502 may fully overlap with a time and a frequency allocation of the second set of DL resources 504.

FIG. 5B is a second diagram 510 illustrating a second example of a resource allocation for (partially-overlapping) in-band full-duplex communication. The resource allocation for IBFD communication may include a first set of UL resources 512 and a second set of DL resources 514. In the second diagram 510, a time and a frequency allocation of the first set of UL resources 512 may partially overlap with a time and a frequency of allocation of the second set of DL resources 514.

In some aspects, a base station may be in full duplex communication with a first UE and a second UE based on the resource allocation illustrated in diagrams 500 and 510. For example, referring to FIG. 4, a first base station 402a is in full duplex communication with a first UE 404a and a second UE 404b. The first base station 402a may be a full-duplex base station, whereas the first UE 404a and the second UE 404b may be configured as either a half-duplex UE or a full-duplex UE. The second UE 404b may transmit a first uplink signal to the first base station 402a as well as to other base stations, such as a third base station (not shown) in proximity to the second UE 404b. The first base station 402a may transmit a downlink signal to the first UE 404a concurrently with receiving the uplink signal from the second UE 404b. In some aspects, the first base station 402a may receive uplink communication with a first antenna panel and may transmit downlink communication with a second antenna panel. Similarly, a UE such as the fourth UE 404d may transmit from one antenna panel and receive from another antenna panel in a full-duplex mode. In some aspects, a full duplex capability may be based on beam separation characteristics between a beam for transmission and a beam for reception. The beam separation characteristic may be based on a measurement of self-interference, a measurement of a clutter echo, etc. The first base station 402a may experience self-interference 440 based on the receiving antenna that is receiving the uplink signal from the second UE 404b receiving some of the downlink signal being transmitted to the first UE 404a. The first base station 402a may experience additional interference 435 due to signals from the second base station 402b. Interference may also occur at the first UE 404a based on signals from third UE 404c, the second base station 402b, as well as from uplink signals from the second UE 404b, e.g., inter-cell interference 420, inter-cell interference 425 and intra-cell interference 430, respectively.

FIG. 5C is a third diagram 520 illustrating a third example of a resource allocation for sub-band full-duplex (SBFD) communication. The resource allocation for SBFD communication may include a first set of UL resources 522 in a first sub-band, a second set of DL resources 524 (e.g., including sub-band DL resource 524a, sub-band DL resource 524b, sub-band DL resource 524c, and sub-band DL resource 524d), and a third set of guard band resources 526. As shown in FIG. 5C, the first set of UL resources 522 are separated from the DL resources in the second set of DL resources 524 by the third set of guard band resources 526. The guard band may be frequency resources, or a gap in frequency resources, provided between the first set of UL resources 522 and the DL resources in the second set of DL resources 524. Separating the UL frequency resources and the DL frequency resources with a guard band may help to reduce self-interference. UL resources and DL resources that are immediately adjacent to each other correspond to a guard band width of 0. As an output signal, e.g., from a UE transmitter, may extend outside the UL resources, the guard band may reduce interference experienced by the UE. Sub-band FDD may also be referred to as “flexible duplex”.

A slot format may be referred to as a “D+U” slot when the slot has a frequency band that is used for both uplink and downlink transmissions. The downlink and uplink transmissions may occur in overlapping frequency resources, such as shown in FIGS. 5A and 5B (e.g., in-band full duplex resources) or may occur in adjacent or slightly separated frequency resources, such as shown in FIG. 5C (e.g., sub-band full duplex resources). In a particular D+U symbol, a half-duplex device may either transmit in the uplink band or receive in the downlink band. In a particular D+U symbol, a full-duplex device may transmit in the uplink band and receive in the downlink band, e.g., in the same symbol or in the same slot. A D+U slot may include downlink only symbols, uplink only symbols, and full-duplex symbols.

The second set of DL resources 524 may be used for communication between the first base station 402a and the second UE 404b while the first set of UL resources 522 may be used for communication between one of the first base station 402a and the second UE 404b or the second base station 402b and the third UE 404c. For example, the set of time resources including the first set of UL resources 522 and the second set of DL resources 524 may be in a flexible slot such that the first base station 402a configures the slot for a DL transmission via the sub-band DL resources 524a-524b while the second base station 402b configures the slot for an UL transmission via the first set of UL resources 522 (e.g., a disjoint sub-band from the sub-bands used for the DL transmissions associated with the first base station).

In some aspects, a base station may be in full duplex communication with a first UE and a second UE based on the resource allocation illustrated in diagrams 500 and 510. For example, referring to FIG. 4, a first base station 402a is in full duplex communication with a first UE 404a and a second UE 404b. In some aspects, a third UE 404c may be a full-duplex UE in communication with a first base station 402a and a second base station 402b or the fourth UE 404d may be in full-duplex communication with a second base station 402b.

The first base station 402a and the second base station 402b may serve as multiple transmission and reception points (multi-TRPs) for UL and DL communication with the UEs 404a-404d. The fourth UE 404d may concurrently transmit an uplink signal to the second base station 402b while receiving a downlink signal from the second base station 402b. The fourth UE 404d may experience self-interference 445, the first UE 404a may experience inter-cell interference 425, or the first UE 404a may experience intra-cell interference 430, as a result of the first signal and the second signal being communicated simultaneously, e.g., the uplink signal may leak to, e.g., be received by, the UE's receiver. The fourth UE 404d may experience additional interference from the third UE 404c.

FIG. 5D is a fourth diagram 530 illustrating a fourth example of a resource allocation for flexible, or dynamic, time division duplexed (TDD) communication. For example, a set of slot designations 538 may indicate that a first set of slots may be downlink (“D”) slots, a second set of slots may be flexible (“F”) slots that may be configured as either DL or UL slots, and a third set of uplink (“U”) slots. Based on the set of slot designations 538, one of the first base station 402a or the second base station 402b may configure slots for communication as illustrated in the fourth diagram 530 to include a first set of DL resources 534 a second set of UL resources 532 and a third guard band 536 that may be configured to provide separation between a DL data transmission via the first set of DL resources 534 and an UL data transmission via the second set of UL resources 532. As shown in FIG. 5D, the second set of UL resources 532 are separated from the first set of DL resources 534 by the third guard band 536. The guard band may be time resources, or a gap in time resources, provided between the second set of UL resources 532 and the first set of DL resources 534. Separating the UL time resources and the DL time resources with a guard band may help to reduce self-interference. UL resources and a DL resources that are immediately adjacent to each other correspond to a guard band width of 0. As an output signal, e.g., from a UE transmitter, may extend outside the UL resources, the guard band may reduce interference experienced by the UE. Sub-band TDD may also be referred to as “flexible duplex”.

As described above, a slot format may be referred to as a “D+U” slot when the slot has a frequency band that is used for both uplink and downlink transmissions. The downlink and uplink transmissions may occur in overlapping frequency resources, such as shown in FIGS. 5A and 5B (e.g., in-band full duplex resources) or may occur in adjacent or slightly separated frequency resources, such as shown in FIG. 5C (e.g., sub-band full duplex resources). In a particular D+U symbol, a half-duplex device may either transmit in the uplink band or receive in the downlink band. In a particular D+U symbol, a full-duplex device may transmit in the uplink band and receive in the downlink band, e.g., in the same symbol or in the same slot. A D+U slot may include downlink only symbols, uplink only symbols, and full-duplex symbols.

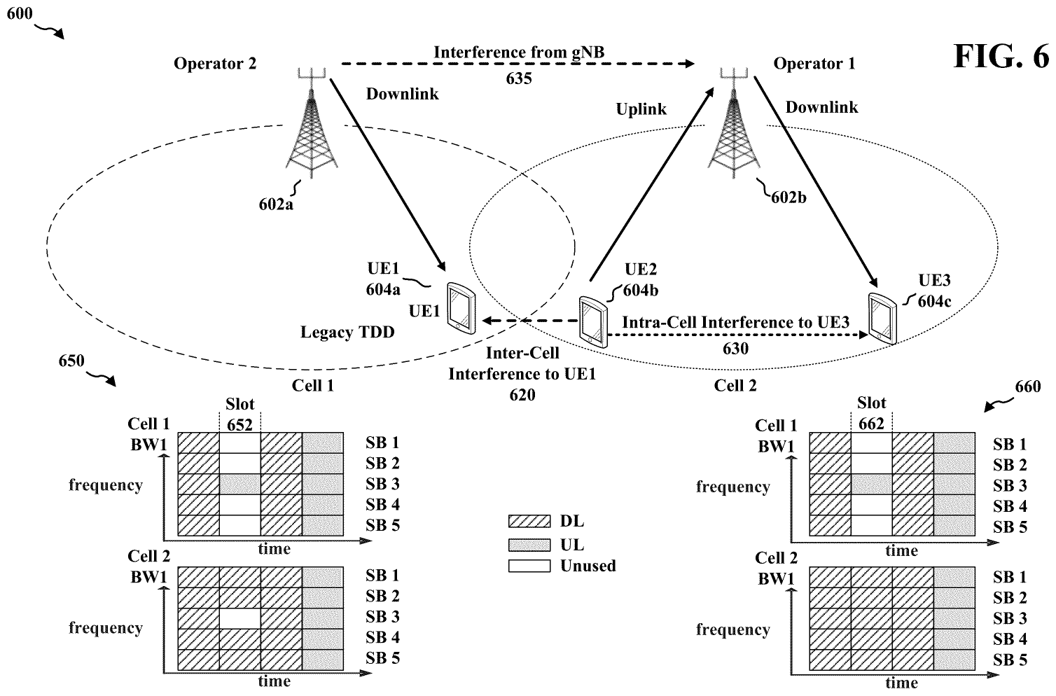

FIG. 6 includes a diagram 600 illustrating various modes of duplexed communications, such as full-duplex communication and time-duplexed communication, between a first base station 602a and a first UE 604a and/or a second base station 602b and one or more of a second UE 604b and/or a third UE 604c. For example, diagrams 650 and 660 illustrate a set of frequency and time resources used by the first base station 602a in a first cell (e.g., cell 1) and a second base station 602b in a second cell (e.g., cell 2) for TDD communication in a set of slots including a flexible (F or D+U) slot 652 or 662. Diagram 650 illustrates that, during the slot 652, a first base station 602a may use a third sub-band (SB 3) for an UL transmission while a second base station 602b may use a set of complementary (non-overlapping) sub-bands (SB1, SB2, SB4, and SB5) for DL transmission(s).

In some aspects, the first base station 602a and the second base station 602b may coordinate the use of complementary sub-bands, while in some aspects, the sub-bands may be autonomously selected and each of a set of data for the UL transmission and a set of data for the DL transmission may occupy less than all the available sub-bands. Diagram 660 illustrates that, during the slot 662, a first base station 602a may use a third sub-band (SB 3) for an UL transmission while the second base station 602b may use the full bandwidth (e.g., including SB3) for DL transmission(s). The slots 652 and 662 may be configured as an UL slot and the third sub-band may be selected for the UL transmission by the first base station 602a independently of a configuration of the slots 652 and 662 as a DL slot for the DL transmission at the second base station 602b. The overlapping or adjacent frequency allocation for UL and DL transmissions may lead to inter-cell interference 620, interference between the base stations 635, or intra-cell interference 630 as described in relation to FIGS. 4 and 5A-5D.

A UE may report CLI measurements. The reception beam that the UE uses for the CLI measurement may be selected by the UE, and the base station may not be aware of the CLI for different reception beams of the UE. A knowledge of the different CLI experienced by different beams of the UE may enable the base station to perform CLI aware beam selection for communication with the UE and/or other UEs. The CLI may be based on layer 3 (L3) measurements, and may be reported by the UE to a base station on periodic CLI resources. A network component such as a CU, e.g., CU 110, may collect CLI reports, and may inform a DU, e.g., DU 130, of the CLI experienced by a UE. Such aspects of the L3 reporting may lead to an amount of latency. Aspects presented herein provide reduced latency in comparison to the L3 reporting and that may enable more timely L1 beam selection in response to interference variation in comparison to such L3 measurements. Configuration updates based on L3 reporting may include a radio resource configuration (RRC) reconfiguration, which may include latency. Aspects presented herein provide CLI information with reduced latency and added flexibility. CLI measurements may include measurements such as a reference signal received power (RSRP) or received signal strength indicator (RSSI) over a wideband.

Aspects presented herein enable CLI measurement information for frequency ranges that are less than the wideband. For example, a UE may provide CLI measurement information at a sub-band level, the information indicating CLI experienced by the UE in a particular sub-band. In some aspects of wireless communication, the ability to perform CLI measurements for each of a plurality of sub-bands may provide additional information at a sub-band level may allow for better resource allocation between UL and DL resources (or better allocation of UL/DL resources among transmissions of different priorities). However, the additional reporting for CLI at individual sub-bands may lead to an increase in signaling overhead compared to reporting a wideband CLI information. Accordingly, a method and apparatus for reducing the overhead associated with sub-band CLI reporting is presented. For example, the reported sub-band CLIs may be limited to those that are above a configured CLI threshold value or a single bit for each sub-band may be added to indicate whether the sub-band is experiencing CLI above (or below) a threshold instead of a multi-bit indication of a CLI metric value. In some aspects, the method and apparatus presented herein provide some of the benefits of per-sub-band CLI reporting while reducing the overhead costs of per-sub-band CLI reporting.

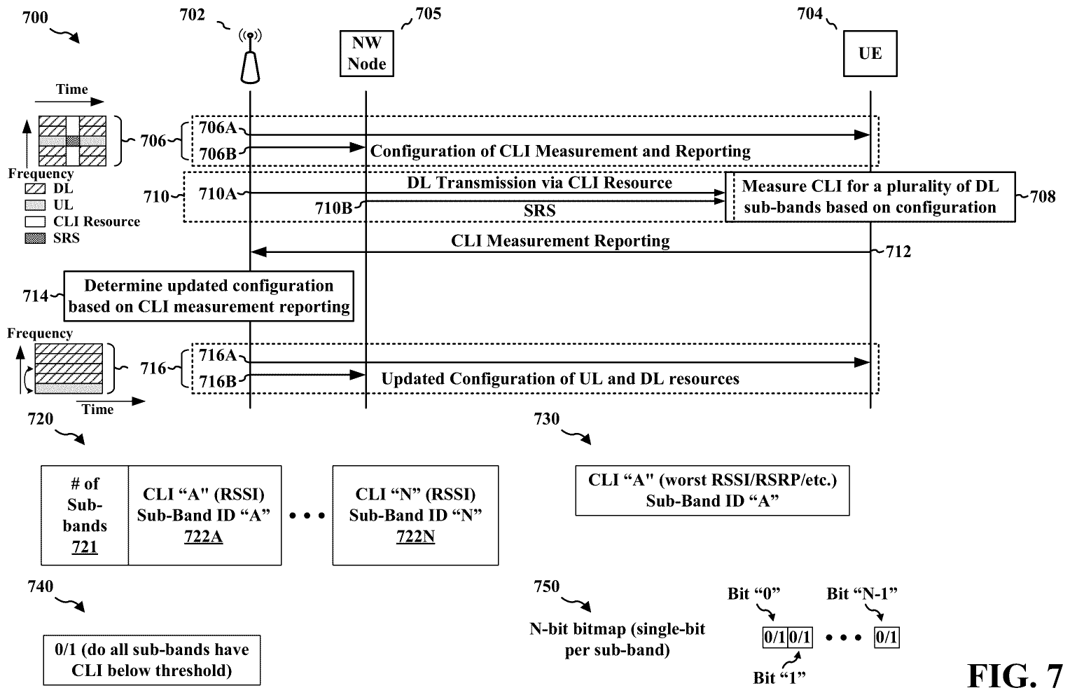

FIG. 7 includes a call flow diagram 700 of a method of wireless communication including at least a UE 704 and two network nodes, e.g., base station 702 and network node 705. The network nodes may be a base station 102, 310 or a component of a base station such as a CU 110, DU 130, and/or RU 140 in accordance with some aspects of the disclosure. The network node may be a base station, or in some aspects, may be a second UE. Call flow diagram 700 illustrates that a network node (e.g., base station 702) may transmit, and the UE 704 may receive, the first configuration 706A for CLI measurement resources and reporting. The configuration may be transmitted via one or more of RRC signaling, a MAC-CE, or DCI. The first configuration 706A may include a configuration for a first set of resources for the UE 704 to measure a CLI metric in each of a plurality of DL sub-bands configured for the UE 704. The network node (e.g., base station 702) may transmit, and a network node 705 may receive, a second configuration 706B for CLI measurement resources and reporting indicating a second set of resources for transmitting the UL transmission (e.g., SRS 710B) from the second UE. The UL transmission, in some aspects, may be an SRS and the second set of resources may include any of: a full bandwidth allocated for UL transmissions, a sub-band of the full bandwidth allocated for the UL transmissions, or a variable number of resource blocks within a set of resource blocks allocated for the UL transmissions. The configuration 706 may further include scheduling information for transmitting information related to the measured CLI based on the configuration 706. The scheduling information may indicate one or more of periodic scheduling, aperiodic scheduling, semi-periodic scheduling, or a triggering event.

Based on the configuration 706, the UE 704 may receive a DL transmission 710A via a CLI resource transmitted by base station 702 and an SRS 710B (or other reference signal) transmitted by a network node 705 (e.g., a second UE or second base station) in a set of simultaneous and/or overlapping transmissions 710. As discussed above, the CLI metric may be used to measure interference to DL reception of the DL transmission 710A at the UE 704 due to the UL transmission, e.g., SRS 710B, from the network node 705 (e.g., the second UE or the second base station). For example, referring to FIGS. 4, 5A-5D, and 6, the first UE 404a or the third UE 604c may receive a DL transmission via DL resources in the second set of DL resources 524 or sub-bands 1, 2, 4, and 5 of slot 652 (or sub-bands 1-5 of slot 662), respectively that may be affected by interference from an UL transmission from a second UE 404b via the first set of UL resources 522 or from an UL transmission from a second UE 604b via the sub-band 3 in slot 652 or 662. The CLI may be measured on a per-sub-band basis to provide finer-grained information than information provided by a channel-wide CLI measurement.

Based on the measured CLI metric and the configuration 706, the UE 704 may generate information relating to the CLI metric measured at 708 for a subset of the plurality of DL sub-bands. The generated information relating to the CLI metric measured at 708 may then be transmitted by UE 704, and received by base station 702, as CLI measurement reporting 712. Diagram 720 illustrates that, in some aspects, the subset of the plurality of DL sub-bands includes a first number, N, of DL sub-bands and may include a CLI metric and a sub-band ID for each DL sub-band (e.g., CLI-metric information 722A to CLI-metric information 722N). The first number, N, in some aspects, may be based on a metric indicated in the configuration 706. In some aspects, the first number of DL sub-bands may be a first number of DL sub-bands for which a corresponding measured CLI is larger than the corresponding measured CLI for each DL sub-band in the plurality of DL sub-bands not included in the subset of DL sub-bands. In other terms, the report may be configured to include the first number, e.g., one or more, of the highest measured CLIs and may include a set of sub-band identifiers for sub-bands associated with the highest measured CLIs.

In some aspects, the first number, N, may be configured based on one or more of a first indication from a network entity (e.g., the base station 702) or a second indication transmitted by the first UE (e.g., the UE 704). The first number, N, in some aspects, is based on a number of measured CLI values above a threshold value. In some aspects, with a variable number of indicated sub-bands (e.g., based on how many sub-bands are associated with a CLI that is larger than a threshold value), the CLI measurement reporting 712 may further include an indication of a number of sub-bands 721 included in the CLI measurement reporting 712. The indication of the number of sub-bands 721 may be implemented as a bitmap indicating DL sub-bands in the subset of the plurality of sub-bands including a single bit for each DL sub-band in the plurality of DL sub-bands or a set of bits capable of representing a number from 1 to the total number, M, of DL sub-bands in the plurality of DL sub-bands (e.g., a set of [log₂ M] bits). Diagram 730 illustrates that, in some aspects, the first number, N, is equal to one and the subset of the plurality of DL sub-bands includes a DL sub-band with a largest corresponding measured CLI.

In some aspects, the CLI measurement reporting 712 may include a single-bit indication reporting the CLI metric for at least one DL sub-band in the plurality of DL sub-bands. Diagram 740 illustrates that, in some aspects, a single-bit indication that may be transmitted to indicate whether all the sub-bands are associated with a CLI that is below a threshold value. For example, the single-bit indication reporting the CLI metric for at least one DL sub-band in the plurality of DL sub-bands may include one single bit indication that jointly indicates whether the CLI metric is below a threshold value for each of the plurality of DL sub-bands. Accordingly, in some aspects, if at least one measured CLI metric for a corresponding at least one DL sub-band in the plurality of DL sub-bands is above the CLI threshold value, the bit may be set to “1”, while if no measured CLI metric for a corresponding DL sub-band is above the CLI threshold value, the bit may be set to “0” (where the meaning of the bit being set to “1” or “0” may be oppositely configured in some aspects). Diagram 750 illustrates that, in some aspects, the single-bit indication reporting the CLI metric for at least one DL sub-band in the plurality of DL sub-bands includes an individual single-bit indication for each of the plurality of DL sub-bands configured for the first UE. In some aspects, each individual single-bit indication indicates whether the CLI metric for a corresponding DL sub-band is above (or below) a threshold value. The indication illustrated in diagram 750 includes a bitmap including a bit for each sub-band to indicate whether the CLI associated with the sub-band is above a threshold or is below a threshold (e.g., indicated by a “1” or “0” value respectively, or vice versa).

In some aspects, the CLI measurement reporting 712 may be transmitted via one or more of layer 1 or layer 2 signaling. Based on the CLI measurement reporting 712, the base station 702 may determine, at 714, an updated resource allocation for the DL transmission to the UE 704 and for the UL transmission from the network node 705. The base station 702 may then transmit an updated configuration 716 of UL and DL resources to UE 704 and to network node 705 via the first updated configuration 716A and the second updated configuration 716B, respectively. For example, based on the CLI measurement reporting 712 regarding the configuration 706, the base station (or network entity) may determine to switch an allocation of a DL sub-band and an UL sub-band indicated in the configuration 706 to produce the resource allocation indicated in the updated configuration 716. The adjustment may be based, in some aspects, on a reported CLI for one or more sub-bands being above a threshold value and a determination or expectation that the adjusted resource allocation may reduce the CLI below the threshold value for each sub-band.

In examples, the resources of the base station 702 and the network node 705 may be configured as all D (e.g., DL) or all U (e.g., UL) at a given time according to a dynamic TDD setting, such as described in connection with FIG. 5D. The DL transmission, e.g., from the base station 702 to the UE 704 may occupy the whole band for a first cell. A resource designated as uplink in the TDD setting of a second cell of the network node 705 may overlap with the DL resources of the first cell. However, the UL transmission of the second cell may occupy only a part of the whole band for the second cell, and the second cell may not use the remaining UL resources for an UL transmission. In such aspects, the UE 704 may experience interference on a part of the whole band partial of the whole band based on the partially overlapping transmission of the second cell. The leaked inter-cell CLI from an UL bandwidth can vary across DL sub-bands of the whole band. The sub-band CLI measurement and reporting, as presented herein, may improve resource allocation, including an allocation and optimization of an UL bandwidth, e.g., at the base station 702 and/or the network node 705.

In some aspects, the communication at the base station 702 and/or the network node 705 may be based on a sub-band dynamic TDD, e.g., as described in connection with the diagram 650 in FIG. 6. With the DL transmission of the first cell, e.g., the base station 702, occupying a set of one or more DL sub-bands, and an UL transmission of the second cell, e.g., the network node 705, occupying UL sub-bands for the second cell, the DL and UL sub-bands may be separated across cells, and leaked inter-cell CLI from an UL bandwidth may vary across the DL sub-bands. The sub-band CLI measurement and reporting presented herein may improve the determination and optimization of DL and UL sub-band configurations in different cells.

In some aspects, a base station, e.g., a base station that communicates in a sub-band full-duplex mode may leak intra-cell CLI from an UL bandwidth that may vary across DL sub-bands. In addition, leaked inter-cell CLI from the UL bandwidth can vary across DL sub-bands. The sub-band CLI measurement and reporting presented herein may improve DL and UL sub-band configuration determination and optimization within a sub-band FD cell and cross cells.

In some aspects, the wireless communication of the two cells, e.g. of the base station 702 and the network node 705, may include fully overlapping sub-band full-duplex communication, in which DL resources occupy the whole band, and UL transmission may occupy a part of the whole band, such as shown in the example in diagram 660 in FIG. 6. Intra-cell CLI may leaked from the UL bandwidth may vary across DL sub-bands. In addition, the leaked inter-cell CLI from an UL bandwidth can vary across DL sub-bands. The sub-band CLI measurement and reporting presented herein may improve UL bandwidth allocation and optimization within a fully overlapping full-duplex cell and across different cells.

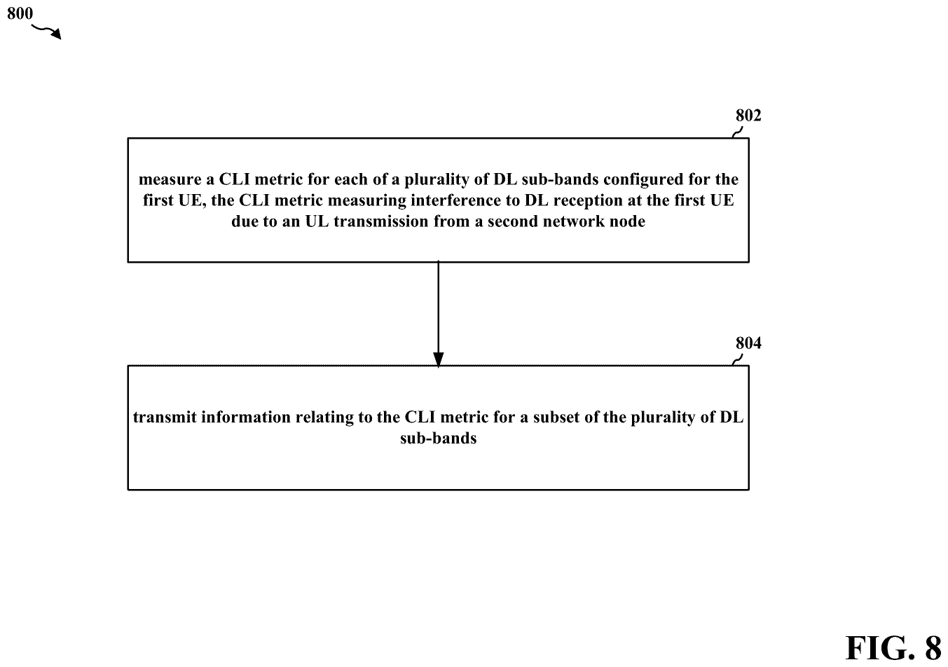

FIG. 8 is a flowchart 800 of a method of wireless communication. The method may be performed by a UE (e.g., the UE 104, 404a, 604c, or 704; the apparatus 1604). Aspects of the method may improve latency for the UE to indicate interference variations and may enable a UE to indicate CLI experienced in particular sub-bands while also minimizing overhead for reporting such CLI to the network.

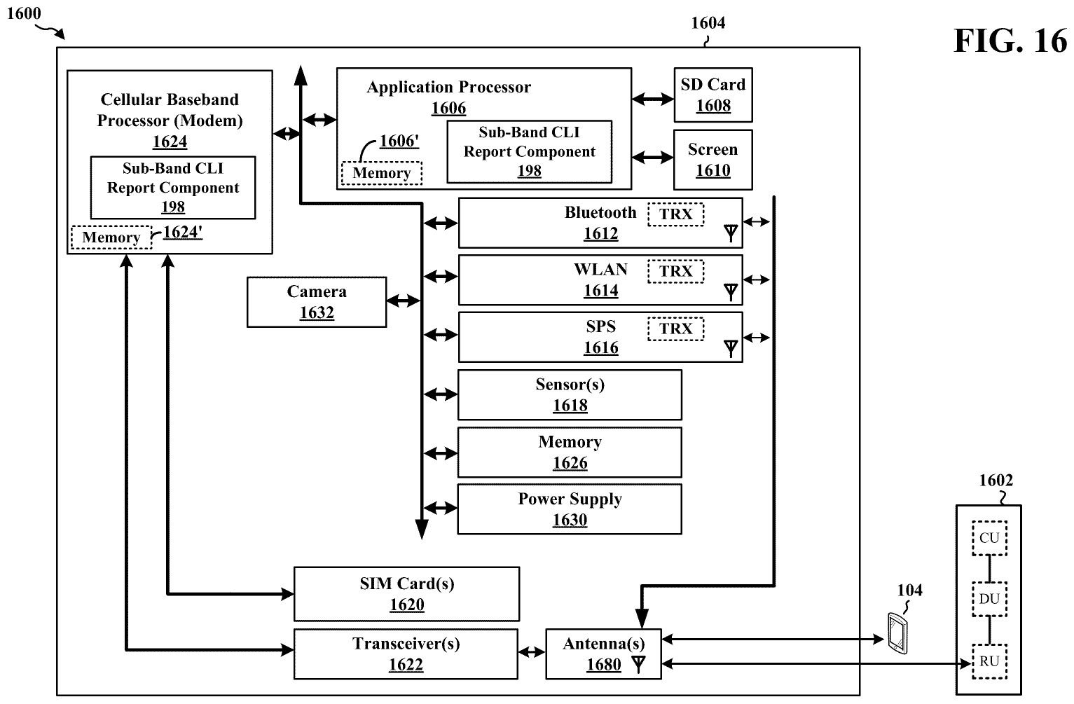

At 802, the UE may measure a CLI metric for each of a plurality of DL sub-bands configured for the first UE. In some aspects, the CLI metric measures interference to DL reception at the first UE due to an UL transmission from a second network node (e.g., a second UE or base station). For example, 802 may be performed by antennas 1680, transceivers 1622, sub-band CLI report component 198, cellular baseband processor (modem) 1624, and/or application processor 1606 of FIG. 16. For example, referring to FIGS. 4, 5A-5D, 6, and 7, the first UE 404a, the third UE 604c, or the UE 704 may measure, at 708, a CLI metric for each DL sub-band in the second set of DL resources 524, the sub-bands 1, 2, 4, and 5 in diagram 650, or sub-bands 1-5 in diagram 660, respectively, or the sub-bands in the resource allocation indicated by the configuration 706. The CLI, in some aspects, may be from an UL transmission via one of the first set of UL resources 522 of the third diagram 520 or sub-band 3 of diagrams 650 and 660 and the CLI metric may be one or more of a RSRP, a received signal strength indicator (RSSI), a reference signal received quality (RSRQ), a signal to interference and noise ratio (SINR), or other relevant metric associated with a DL sub-band.

In some aspects, the UE may receive, from a base station or network node, a first indication of a configuration of a first set of resources for measuring the CLI metric for each of the plurality of DL sub-bands. A second network node, in some aspects, may receive a second set of resources for transmitting the UL transmission from the second network node. The UE, in some aspects, may measure the CLI metric at 802 based on the received configuration. For example, the configuration may be received by antennas 1680, transceivers 1622, sub-band CLI report component 198, cellular baseband processor (modem) 1624, or application processor 1606. For example, referring to FIG. 7, the UE 704 may receive the configuration 706A for CLI measurement resources and reporting including an indication of DL resources, UL resources, CLI resources, and SRS resources.

At 804, the UE may transmit information relating to the CLI metric for a subset of the plurality of DL sub-bands. For example, 804 may be performed by antennas 1680, transceivers 1622, sub-band CLI report component 198, cellular baseband processor (modem) 1624, and/or application processor 1606 of FIG. 16. In some aspects, the subset of the plurality of DL sub-bands includes a first number of DL sub-bands for which a corresponding measured CLI is larger than the corresponding measured CLI for each DL sub-band in the plurality of DL sub-bands not included in the subset of DL sub-bands. The first number, in some aspects, may be equal to one and the subset of the plurality of DL sub-bands may include a DL sub-band with a largest corresponding measured CLI. In some aspects, the first number is one of: a second number configured based on one or more of a first indication from a network node or a second indication (recommended and) transmitted by the first UE, or a third number of measured CLI values above a threshold value. In aspects for which the first number is the third number of measured CLI values, the information relating to the CLI metric for the subset of the plurality of DL sub-bands may further include an indication of a number of sub-bands included in the subset of the plurality of DL sub-bands. The information relating to the CLI metric for the subset of the plurality of DL sub-bands, in some aspects, may include a set of DL sub-band IDs, wherein the set of DL sub-band IDs indicates DL sub-bands in the subset of the plurality of DL sub-bands. For example, referring to FIG. 7, the UE 704 may transmit CLI measurement reporting 712 including information relating to the CLI metric for a subset of the plurality of DL sub-bands as depicted in diagrams 720 and 730.

In some aspects, the information relating to the subset of the plurality of CLI metrics is transmitted via one or more of layer 1 or layer 2 signaling. The information relating to the CLI metric for the subset of the plurality of DL sub-bands, in some aspects, may be transmitted based on one or more of periodic scheduling, aperiodic scheduling, semi-periodic scheduling, or a triggering event. The timing of the transmission of the information relating to the CLI metric for the subset of the plurality of DL sub-bands, in some aspects, is indicated in the first indication of the configuration of the first set of resources for measuring the CLI metric for each of the plurality of DL sub-bands.

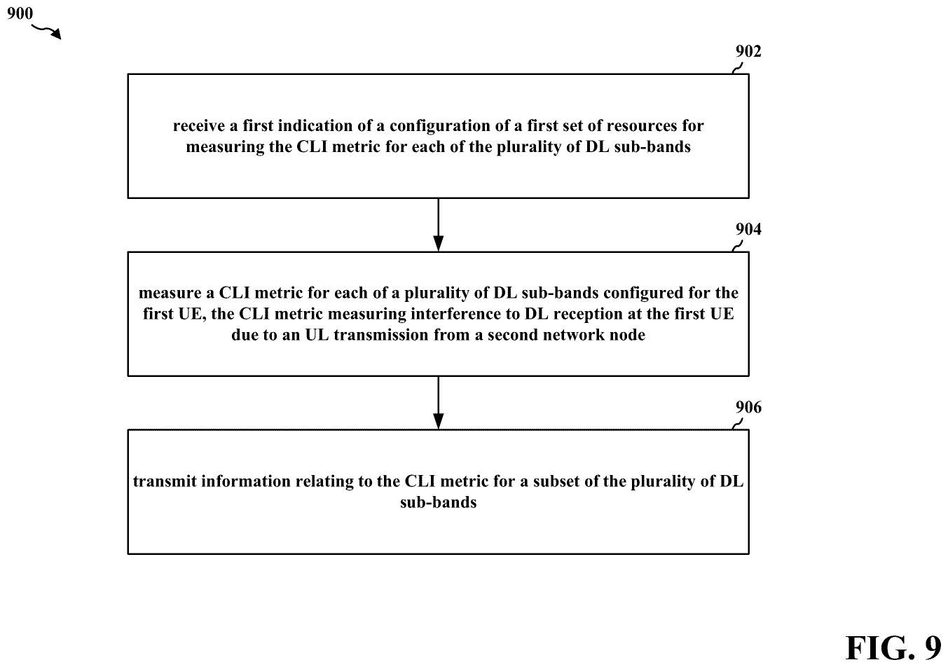

FIG. 9 is a flowchart 900 of a method of wireless communication. The method may be performed by a UE (e.g., the UE 104, 404a, 604c, or 704; the apparatus 1604). Aspects of the method may improve latency for the UE to indicate interference variations and may enable a UE to indicate CLI experienced in particular sub-bands while also minimizing overhead for reporting such CLI to the network.

At 902, the UE may receive, from a base station or network node, a first indication of a configuration of a first set of resources for measuring the CLI metric for each of the plurality of DL sub-bands. A second network node, in some aspects, may receive a second set of resources for transmitting the UL transmission from the second network node. The UE, in some aspects, may measure the CLI metric at 904 based on the received configuration. For example, 902 may be performed by antennas 1680, transceivers 1622, sub-band CLI report component 198, cellular baseband processor (modem) 1624, or application processor 1606. For example, referring to FIG. 7, the UE 704 may receive the configuration 706A for CLI measurement resources and reporting including an indication of DL resources, UL resources, CLI resources, and SRS resources.

At 904, based on the configuration received at 902, the UE may measure a CLI metric for each of a plurality of DL sub-bands configured for the first UE. In some aspects, the CLI metric measures interference to DL reception at the first UE due to an UL transmission from a second network node (e.g., a second UE or base station). For example, 904 may be performed by antennas 1680, transceivers 1622, sub-band CLI report component 198, cellular baseband processor (modem) 1624, and/or application processor 1606 of FIG. 16. For example, referring to FIGS. 4, 5A-5D, 6, and 7, the first UE 404a, the third UE 604c, or the UE 704 may measure, at 708, a CLI metric for each DL sub-band in the second set of DL resources 524, the sub-bands 1, 2, 4, and 5 in diagram 650, or sub-bands 1-5 in diagram 660, respectively, or the sub-bands in the resource allocation indicated by the configuration 706. The CLI, in some aspects, may be from an UL transmission via one of the first set of UL resources 522 of the third diagram 520 or sub-band 3 of diagrams 650 and 660 and the CLI metric may be one or more of a RSRP, a RSSI, a RSRQ, a SINR, or other relevant metric associated with a DL sub-band.

At 906, the UE may transmit information relating to the CLI metric for a subset of the plurality of DL sub-bands. For example, 906 may be performed by antennas 1680, transceivers 1622, sub-band CLI report component 198, cellular baseband processor (modem) 1624, or application processor 1606. In some aspects, the subset of the plurality of DL sub-bands includes a first number of DL sub-bands for which a corresponding measured CLI is larger than the corresponding measured CLI for each DL sub-band in the plurality of DL sub-bands not included in the subset of DL sub-bands. The first number, in some aspects, may be equal to one and the subset of the plurality of DL sub-bands may include a DL sub-band with a largest corresponding measured CLI. In some aspects, the first number is one of: a second number configured based on one or more of a first indication from a network node or a second indication (recommended and) transmitted by the first UE, or a third number of measured CLI values above a threshold value. In aspects for which the first number is the third number of measured CLI values, the information relating to the CLI metric for the subset of the plurality of DL sub-bands may further include an indication of a number of sub-bands included in the subset of the plurality of DL sub-bands. The information relating to the CLI metric for the subset of the plurality of DL sub-bands, in some aspects, may include a set of DL sub-band IDs, wherein the set of DL sub-band IDs indicates DL sub-bands in the subset of the plurality of DL sub-bands. For example, referring to FIG. 7, the UE 704 may transmit CLI measurement reporting 712 including information relating to the CLI metric for a subset of the plurality of DL sub-bands as depicted in diagrams 720 and 730.

In some aspects, the information relating to the subset of the plurality of CLI metrics is transmitted via one or more of layer 1 or layer 2 signaling. The information relating to the CLI metric for the subset of the plurality of DL sub-bands, in some aspects, may be transmitted based on one or more of periodic scheduling, aperiodic scheduling, semi-periodic scheduling, or a triggering event. The timing of the transmission of the information relating to the CLI metric for the subset of the plurality of DL sub-bands, in some aspects, is indicated in the first indication of the configuration of the first set of resources for measuring the CLI metric for each of the plurality of DL sub-bands received at 902.

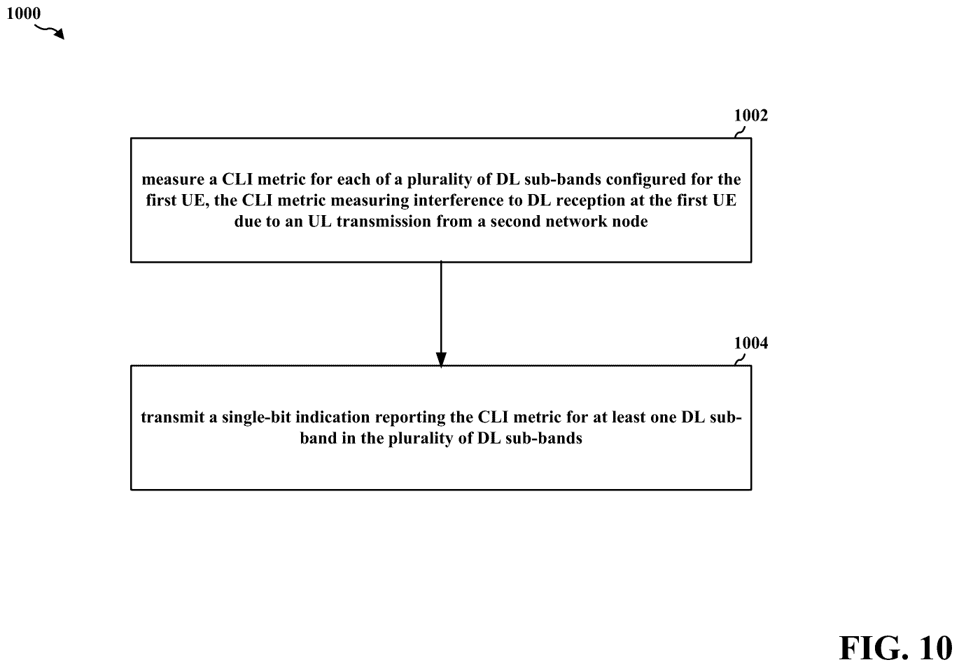

FIG. 10 is a flowchart 1000 of a method of wireless communication. The method may be performed by a UE (e.g., the UE 104, 404a, 604c, or 704; the apparatus 1604). At 1002, the UE may measure a CLI metric for each of a plurality of DL sub-bands configured for the first UE. In some aspects, the CLI metric measures interference to DL reception at the first UE due to an UL transmission from a second network node (e.g., a second UE or base station). For example, 1002 may be performed by antennas 1680, transceivers 1622, sub-band CLI report component 198, cellular baseband processor (modem) 1624, and/or application processor 1606 of FIG. 16. For example, referring to FIGS. 4, 5A-5D, 6, and 7, the first UE 404a, the third UE 604c, or the UE 704 may measure, at 708, a CLI metric for each DL sub-band in the second set of DL resources 524, the sub-bands 1, 2, 4, and 5 in diagram 650, or sub-bands 1-5 in diagram 660, respectively, or the sub-bands in the resource allocation indicated by the configuration 706. The CLI, in some aspects, may be from an UL transmission via one of the first set of UL resources 522 of the third diagram 520 or sub-band 3 of diagrams 650 and 660 and the CLI metric may be one or more of a RSRP, a RSSI, a RSRQ, a SINR, or other relevant metric associated with a DL sub-band.

In some aspects, the UE may receive, from a base station or network node, a first indication of a configuration of a first set of resources for measuring the CLI metric for each of the plurality of DL sub-bands. A second network node, in some aspects, may receive a second set of resources for transmitting the UL transmission from the second network node. The UE, in some aspects, may measure the CLI metric at 1002 based on the received configuration. For example, the configuration may be received by antennas 1680, transceivers 1622, sub-band CLI report component 198, cellular baseband processor (modem) 1624, or application processor 1606. For example, referring to FIG. 7, the UE 704 may receive the configuration 706A for CLI measurement resources and reporting including an indication of DL resources, UL resources, CLI resources, and SRS resources.

At 1004, the UE may transmit a single-bit indication reporting the CLI metric for at least one DL sub-band in the plurality of DL sub-bands. For example, 1004 may be performed by antennas 1680, transceivers 1622, sub-band CLI report component 198, cellular baseband processor (modem) 1624, or application processor 1606. The single-bit indication reporting the CLI metric for at least one DL sub-band in the plurality of DL sub-bands, in some aspects, may include an individual single-bit indication for each of the plurality of DL sub-bands configured for the first UE. In some aspects, each individual single-bit indication indicates whether the CLI metric for a corresponding DL sub-band is above (or below) a threshold value. The single-bit indication reporting the CLI metric for at least one DL sub-band in the plurality of DL sub-bands may include one single bit indication that jointly indicates whether the CLI metric is below (or above) a threshold value for each of the plurality of DL sub-bands. For example, referring to FIG. 7, the UE 704 may transmit CLI measurement reporting 712 including a single-bit indication reporting the CLI metric for the at least one DL sub-band in the plurality of DL sub-bands as depicted in diagrams 740 and 750.

In some aspects, the single-bit indication reporting the CLI metric for the at least one DL sub-band in the plurality of DL sub-bands may be transmitted via one or more of layer 1 or layer 2 signaling. The info single-bit indication reporting the CLI metric for the at least one DL sub-band in the plurality of DL sub-bands, in some aspects, may be transmitted based on one or more of periodic scheduling, aperiodic scheduling, semi-periodic scheduling, or a triggering event. The timing of the transmission of the single-bit indication reporting the CLI metric for the at least one DL sub-band in the plurality of DL sub-bands, in some aspects, is indicated in the first indication of the configuration of the first set of resources for measuring the CLI metric for each of the plurality of DL sub-bands.

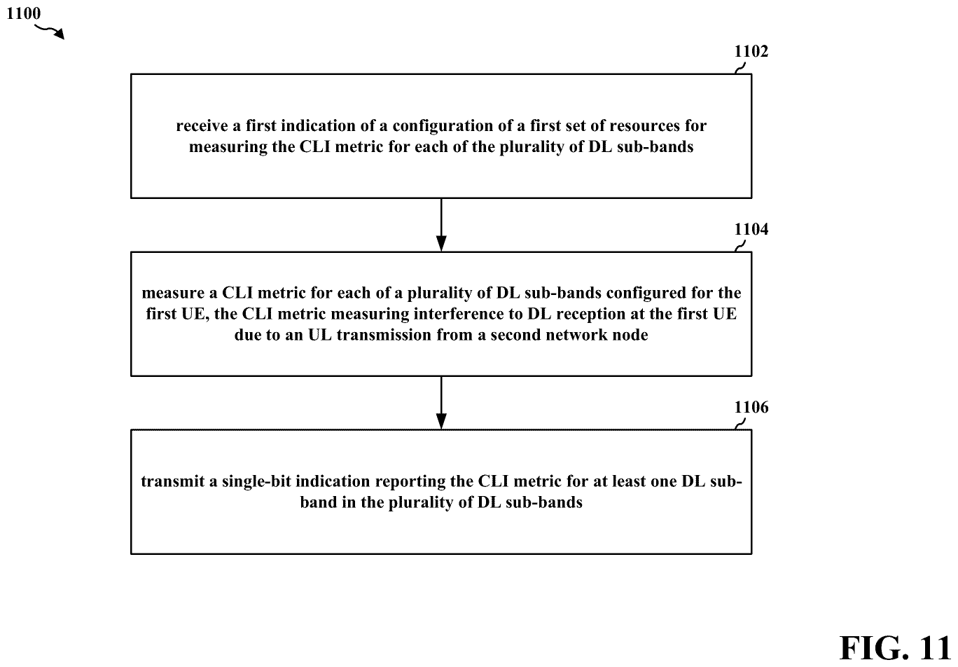

FIG. 11 is a flowchart 1100 of a method of wireless communication. The method may be performed by a UE (e.g., the UE 104, 404a, 604c, or 704; the apparatus 1604). Aspects of the method may improve latency for the UE to indicate interference variations and may enable a UE to indicate CLI experienced in particular sub-bands while also minimizing overhead for reporting such CLI to the network.

At 1102, the UE may receive, from a base station or network node, a first indication of a configuration of a first set of resources for measuring the CLI metric for each of the plurality of DL sub-bands. A second network node, in some aspects, may receive a second set of resources for transmitting the UL transmission from the second network node. The UE, in some aspects, may measure the CLI metric at 1104 based on the received configuration. For example, 1102 may be performed by antennas 1680, transceivers 1622, sub-band CLI report component 198, cellular baseband processor (modem) 1624, or application processor 1606 of FIG. 16. For example, referring to FIG. 7, the UE 704 may receive the configuration 706A for CLI measurement resources and reporting including an indication of DL resources, UL resources, CLI resources, and SRS resources.

At 1104, based on the configuration received at 1102, the UE may measure a CLI metric for each of a plurality of DL sub-bands configured for the first UE. In some aspects, the CLI metric measures interference to DL reception at the first UE due to an UL transmission from a second network node (e.g., a second UE or base station). For example, 1104 may be performed by antennas 1680, transceivers 1622, sub-band CLI report component 198, cellular baseband processor (modem) 1624, and/or application processor 1606 of FIG. 16. For example, referring to FIGS. 4, 5A-5D, 6, and 7, the first UE 404a, the third UE 604c, or the UE 704 may measure, at 708, a CLI metric for each DL sub-band in the second set of DL resources 524, the sub-bands 1, 2, 4, and 5 in diagram 650, or sub-bands 1-5 in diagram 660, respectively, or the sub-bands in the resource allocation indicated by the configuration 706. The CLI, in some aspects, may be from an UL transmission via one of the first set of UL resources 522 of the third diagram 520 or sub-band 3 of diagrams 650 and 660 and the CLI metric may be one or more of a RSRP, a RSSI, a RSRQ, a SINR, or other relevant metric associated with a DL sub-band.

At 1106, the UE may transmit a single-bit indication reporting the CLI metric for at least one DL sub-band in the plurality of DL sub-bands. For example, 1106 may be performed by antennas 1680, transceivers 1622, sub-band CLI report component 198, cellular baseband processor (modem) 1624, or application processor 1606. The single-bit indication reporting the CLI metric for the at least one DL sub-band in the plurality of DL sub-bands, in some aspects, may include an individual single-bit indication for each of the plurality of DL sub-bands configured for the first UE. In some aspects, each individual single-bit indication indicates whether the CLI metric for a corresponding DL sub-band is above (or below) a threshold value. The single-bit indication reporting the CLI metric for the at least one DL sub-band in the plurality of DL sub-bands may include one single bit indication that jointly indicates whether the CLI metric is below (or above) a threshold value for each of the plurality of DL sub-bands. For example, referring to FIG. 7, the UE 704 may transmit CLI measurement reporting 712 including a single-bit indication reporting the CLI metric for the at least one DL sub-band in the plurality of DL sub-bands as depicted in diagrams 740 and 750.

In some aspects, the single-bit indication reporting the CLI metric for the at least one DL sub-band in the plurality of DL sub-bands may be transmitted via one or more of layer 1 or layer 2 signaling. The info single-bit indication reporting the CLI metric for the at least one DL sub-band in the plurality of DL sub-bands, in some aspects, may be transmitted based on one or more of periodic scheduling, aperiodic scheduling, semi-periodic scheduling, or a triggering event. The timing of the transmission of the single-bit indication reporting the CLI metric for the at least one DL sub-band in the plurality of DL sub-bands, in some aspects, is indicated in the first indication of the configuration of the first set of resources for measuring the CLI metric for each of the plurality of DL sub-bands received at 1102.

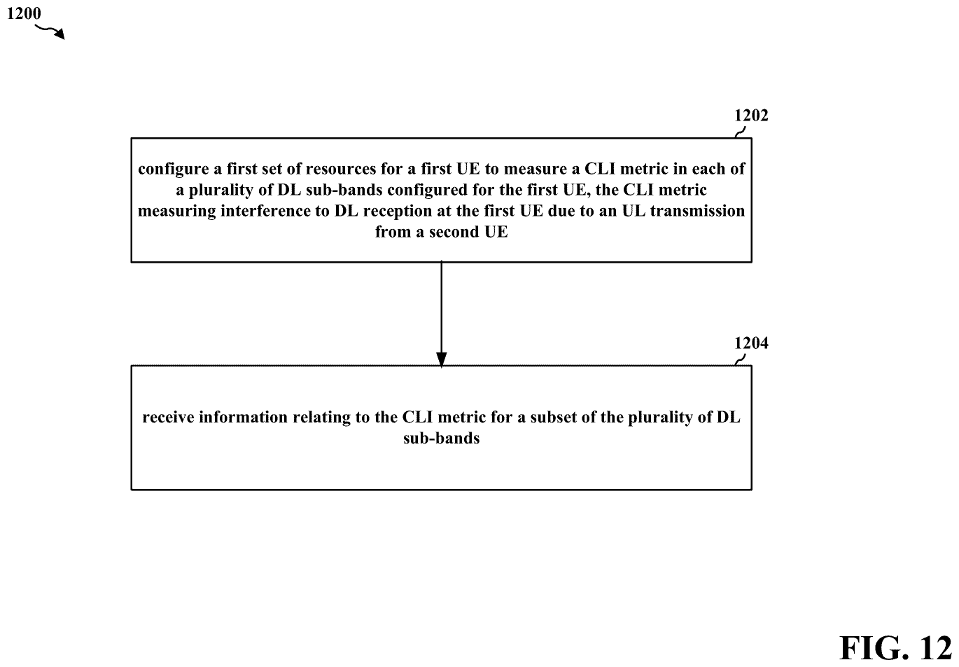

FIG. 12 is a flowchart 1200 of a method of wireless communication. The method may be performed by a network node, or base station, (e.g., the base station 102, 402a, 602b, or 702; the CU 110; the DU 130; the RU 140; the network node 1602; the network entity 1702). Aspects of the method may improve the reception of information from UEs for interference variations, including CLI experienced in particular sub-bands while also minimizing overhead for such CLI reports. The improved information may assist the network node in allocating resources for wireless communication.

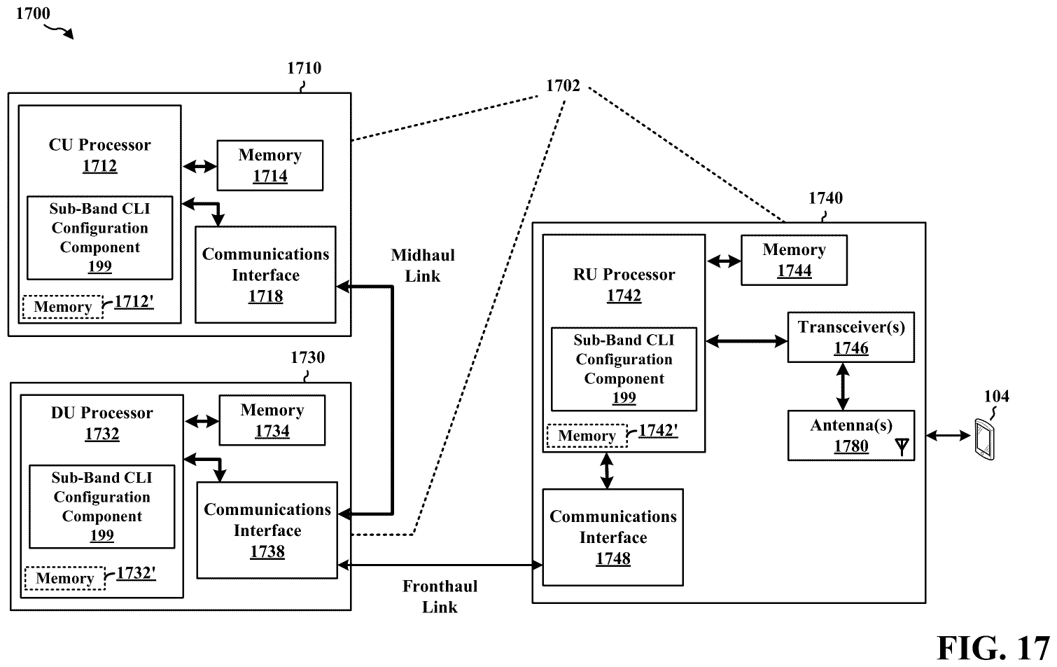

At 1202, the base station may configure a first set of resources for a first UE to measure a CLI metric in each of a plurality of DL sub-bands configured for the first UE. In some aspects, the CLI metric measures interference to DL reception at the first UE due to an UL transmission from a second network node (e.g., a second UE or a second base station). For example, 1202 may be performed by CU processor 1712, DU processor 1732, RU processor 1742, transceiver(s) 1746, antenna(s) 1780, and/or sub-band CLI configuration component 199 of FIG. 17. In some aspects, configuring the first set of resources at 1202 may include transmitting an indication of the configured first set of resources to the first UE. The indication, in some aspects, may further include an indication of a reporting configuration, e.g., an indication of what to report and how to report it as discussed above. For example, referring to FIGS. 4, 5A-5D, 6, and 7, the base station 402a, 602b, or 702 may configure, via the first configuration 706A, the first set of resources (e.g., the second set of DL resources 524, the sub-bands 1, 2, 4, and 5 in diagram 650, the sub-bands 1-5 in diagram 660, or the DL resources in the resource allocation indicated by the configuration 706) for the first UE 404a, the third UE 604c, or the UE 704 to use to measure, at 708, a CLI metric in each of the plurality of DL sub-bands configured for the first UE. The CLI, in some aspects, may be from an UL transmission via one of the first set of UL resources 522 of the third diagram 520 or sub-band 3 of diagrams 650 and 660 and the CLI metric may be one or more of a RSRP, a RSSI, a RSRQ, a SINR, or other relevant metric associated with a DL sub-band.

In some aspects, the base station 402a, 602b, or 702 may further configure, via the second configuration 706B, a second set of resources for transmitting the UL transmission from the second network node (e.g., the second UE or the second BS). For example, configuring the second set of resources may be performed by CU processor 1712, DU processor 1732, RU processor 1742, transceiver(s) 1746, antenna(s) 1780, and/or sub-band CLI configuration component 199 of FIG. 17. The UL transmission, in some aspects, may be an SRS. In some aspects, the second set of resources may include any of a full bandwidth allocated for UL transmissions, a sub-band of the full bandwidth allocated for the UL transmissions, or a variable number of resource blocks within a set of resource blocks allocated for the UL transmissions. For example, referring to FIGS. 4, 5A-5D, 6, and 7, the base station 402a, 602b, or 702 may configure, via the second configuration 706B, the second set of resources (e.g., the set of the first set of UL resources 522, the sub-band 3 in diagrams 650 and 660, or the UL resources and/or the SRS resources in the resource allocation indicated by the configuration 706) for a second network node (e.g., the second UE 404b or 604b, or the network node 705) to use to transmit an UL transmission that may cause CLI at the first UE 404a, the third UE 604c, or the UE 704.

The first UE may measure CLI from the second network node based on the configuration and the base station may receive, at 1204, information relating to the CLI metric for a subset of the plurality of DL sub-bands. For example, 1204 may be performed by CU processor 1712, DU processor 1732, RU processor 1742, transceiver(s) 1746, antenna(s) 1780, and/or sub-band CLI configuration component 199 of FIG. 17. In some aspects, the subset of the plurality of DL sub-bands may include a first number of DL sub-bands for which a corresponding measured CLI is larger than the corresponding measured CLI for each DL sub-band in the plurality of DL sub-bands not included in the subset of DL sub-bands. The first number, in some aspects, may be equal to one and the subset of the plurality of DL sub-bands may include a DL sub-band with a largest corresponding measured CLI. In some aspects, the first number is one of: a second number configured based on one or more of a first indication from a network node (e.g., the base station) or a second indication (recommended and) transmitted by the first UE, or a third number of measured CLI values above a threshold value. In aspects for which the first number is the third number of measured CLI values, the information relating to the CLI metric for the subset of the plurality of DL sub-bands may further include an indication of a number of sub-bands included in the subset of the plurality of DL sub-bands. The information relating to the CLI metric for the subset of the plurality of DL sub-bands, in some aspects, includes a set of DL sub-band IDs, wherein the set of DL sub-band IDs indicates DL sub-bands in the subset of the plurality of DL sub-bands. For example, referring to FIG. 7, the base station 702, and the UE 704 may transmit, CLI measurement reporting 712 including information relating to the CLI metric for a subset of the plurality of DL sub-bands as depicted in diagrams 720 and 730.

In some aspects, the information relating to the subset of the plurality of CLI metrics is received via one or more of layer 1 or layer 2 signaling. The information relating to the CLI metric for the subset of the plurality of DL sub-bands, in some aspects, may be received based on one or more of periodic scheduling, aperiodic scheduling, semi-periodic scheduling, or a triggering event. The timing of the transmission of the information relating to the CLI metric for the subset of the plurality of DL sub-bands, in some aspects, may be indicated in the configuration of the first set of resources for measuring the CLI metric for each of the plurality of DL sub-bands.

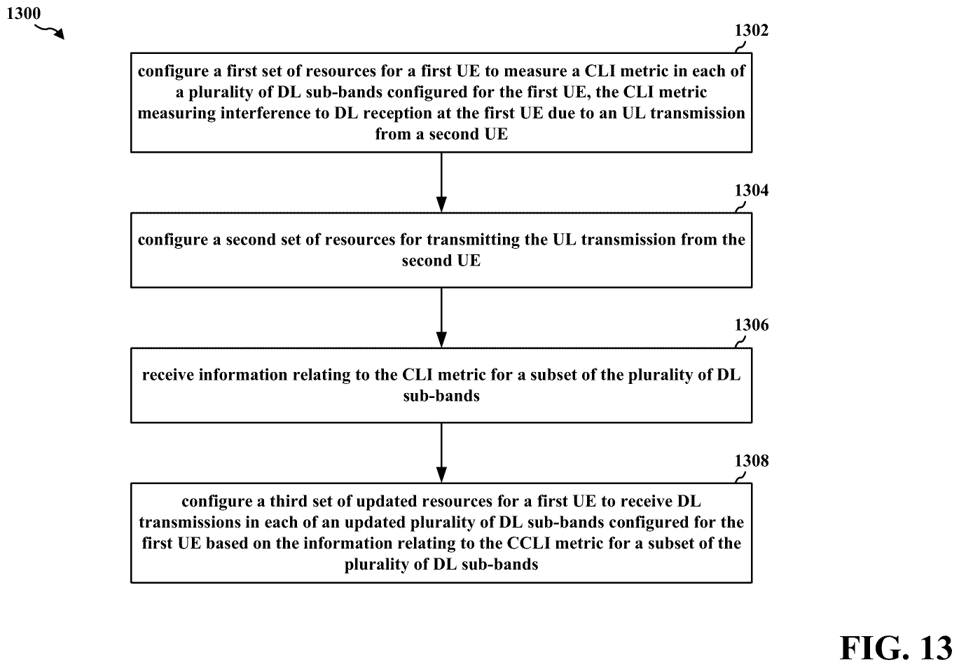

FIG. 13 is a flowchart 1300 of a method of wireless communication. The method may be performed by a network node, or base station, (e.g., the base station 102, 402a, 602b, or 702; the CU 110; the DU 130; the RU 140; the network node 1602; the network entity 1702). Aspects of the method may improve the reception of information from UEs for interference variations, including CLI experienced in particular sub-bands while also minimizing overhead for such CLI reports. The improved information may assist the network node in allocating resources for wireless communication.

At 1302, the base station may configure a first set of resources for a first UE to measure a CLI metric in each of a plurality of DL sub-bands configured for the first UE. In some aspects, the CLI metric measures interference to DL reception at the first UE due to an UL transmission from a second network node (e.g., a second UE or a second base station). For example, 1302 may be performed by CU processor 1712, DU processor 1732, RU processor 1742, transceiver(s) 1746, antenna(s) 1780, and/or sub-band CLI configuration component 199 of FIG. 17. In some aspects, configuring the first set of resources at 1302 may include transmitting an indication of the configured first set of resources to the first UE. The indication, in some aspects, may further include an indication of a reporting configuration, e.g., an indication of what to report and how to report it as discussed above. For example, referring to FIGS. 4, 5A-5D, 6, and 7, the base station 402a, 602b, or 702 may configure, via the first configuration 706A, the first set of resources (e.g., the second set of DL resources 524, the sub-bands 1, 2, 4, and 5 in diagram 650, the sub-bands 1-5 in diagram 660, or the DL resources in the resource allocation indicated by the configuration 706) for the first UE 404a, the third UE 604c, or the UE 704 to use to measure, at 708, a CLI metric in each of the plurality of DL sub-bands configured for the first UE. The CLI, in some aspects, may be from an UL transmission via one of the first set of UL resources 522 of the third diagram 520 or sub-band 3 of diagrams 650 and 660 and the CLI metric may be one or more of a RSRP, a RSSI, a RSRQ, a SINR, or other relevant metric associated with a DL sub-band.

At 1304, the base station may further configure, via the second configuration, a second set of resources for transmitting the UL transmission from the second network node (e.g., the second UE or the second BS). For example, 1304 may be performed by CU processor 1712, DU processor 1732, RU processor 1742, transceiver(s) 1746, antenna(s) 1780, and/or sub-band CLI configuration component 199 of FIG. 17. The UL transmission, in some aspects, may be an SRS. In some aspects, the second set of resources may include any of a full bandwidth allocated for UL transmissions, a sub-band of the full bandwidth allocated for the UL transmissions, or a variable number of resource blocks within a set of resource blocks allocated for the UL transmissions. For example, referring to FIGS. 4, 5A-5D, 6, and 7, the base station 402a, 602b, or 702 may configure, via the second configuration 706B, the second set of resources (e.g., the set of the first set of UL resources 522, the sub-band 3 in diagrams 650 and 660, or the UL resources and/or the SRS resources in the resource allocation indicated by the configuration 706) for a second network node (e.g., the second UE 404b or 604b, or the network node 705) to use to transmit an UL transmission that may cause CLI at the first UE 404a, the third UE 604c, or the UE 704.

The first UE may measure CLI from the second network node based on the configuration and the base station may receive, at 1306, information relating to the CLI metric for a subset of the plurality of DL sub-bands. For example, 1306 may be performed by CU processor 1712, DU processor 1732, RU processor 1742, transceiver(s) 1746, antenna(s) 1780, and/or sub-band CLI configuration component 199 of FIG. 17. In some aspects, the subset of the plurality of DL sub-bands includes a first number of DL sub-bands for which a corresponding measured CLI is larger than the corresponding measured CLI for each DL sub-band in the plurality of DL sub-bands not included in the subset of DL sub-bands. The first number, in some aspects, may be equal to one and the subset of the plurality of DL sub-bands may include a DL sub-band with a largest corresponding measured CLI. In some aspects, the first number is one of: a second number configured based on one or more of a first indication from a network node (e.g., the base station) or a second indication (recommended and) transmitted by the first UE, or a third number of measured CLI values above a threshold value. In aspects for which the first number is the third number of measured CLI values, the information relating to the CLI metric for the subset of the plurality of DL sub-bands may further include an indication of a number of sub-bands included in the subset of the plurality of DL sub-bands. The information relating to the CLI metric for the subset of the plurality of DL sub-bands, in some aspects, may include a set of DL sub-band IDs, wherein the set of DL sub-band IDs indicates DL sub-bands in the subset of the plurality of DL sub-bands. For example, referring to FIG. 7, the base station 702, and the UE 704 may transmit, CLI measurement reporting 712 including information relating to the CLI metric for a subset of the plurality of DL sub-bands as depicted in diagrams 720 and 730.

In some aspects, the information relating to the subset of the plurality of CLI metrics is received via one or more of layer 1 or layer 2 signaling. The information relating to the CLI metric for the subset of the plurality of DL sub-bands, in some aspects, may be received based on one or more of periodic scheduling, aperiodic scheduling, semi-periodic scheduling, or a triggering event. The timing of the transmission of the information relating to the CLI metric for the subset of the plurality of DL sub-bands, in some aspects, may be indicated in the configuration of the first set of resources for measuring the CLI metric for each of the plurality of DL sub-bands.

Finally, at 1308, the base station may configure a third set of updated resources for a first UE to receive DL transmissions in each of an updated plurality of DL sub-bands configured for the first UE based on the information relating to the CLI metric for a subset of the plurality of DL sub-bands. For example, 1308 may be performed by CU processor 1712, DU processor 1732, RU processor 1742, transceiver(s) 1746, antenna(s) 1780, and/or sub-band CLI configuration component 199 of FIG. 17. The base station may determine, based on the information relating to the subset of the plurality of CLI metrics received at 1306, an optimized (or improved) configuration of DL sub-band resources and UL sub-band resources to reduce CLI experienced by the first UE, by adjusting the location of the UL sub-band resource(s) in relation to the DL sub-band resource(s). In some aspects, the base station may optimize the data sent using the different sub-bands, e.g., using sub-bands experiencing high CLI to transmit low-priority data and using sub-bands experiencing low CLI to transmit higher-priority data. For example, referring to FIG. 7, the base station 702 may determine, at 714, an updated configuration based on the CLI measurement reporting 712 and may configure a third set of updated resources for the first UE to receive DL transmission in each of the updated plurality of DL sub-bands via the first updated configuration 716A transmitted to, and received by, the UE 704. The updated configuration 716 indicates, for example, that a location of an UL sub-band resource and a DL resource have been swapped in the updated configuration 716 when compared with the configuration 706.

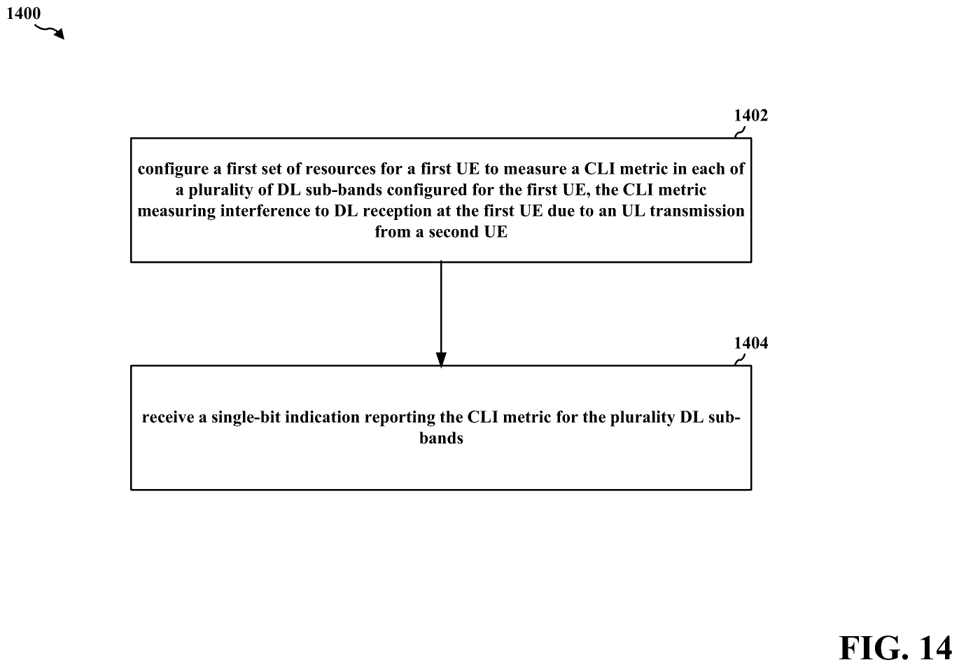

FIG. 14 is a flowchart 1400 of a method of wireless communication. The method may be performed by a network node, or base station, (e.g., the base station 102, 402a, 602b, or 702; the CU 110; the DU 130; the RU 140; the network node 1602; the network entity 1702). Aspects of the method may improve the reception of information from UEs for interference variations, including CLI experienced in particular sub-bands while also minimizing overhead for such CLI reports. The improved information may assist the network node in allocating resources for wireless communication.

At 1402, the base station may configure a first set of resources for a first UE to measure a CLI metric in each of a plurality of DL sub-bands configured for the first UE. In some aspects, the CLI metric measures interference to DL reception at the first UE due to an UL transmission from a second network node (e.g., a second UE or a second base station). For example, 1402 may be performed by CU processor 1712, DU processor 1732, RU processor 1742, transceiver(s) 1746, antenna(s) 1780, and/or sub-band CLI configuration component 199 of FIG. 17. In some aspects, configuring the first set of resources at 1402 may include transmitting an indication of the configured first set of resources to the first UE. The indication, in some aspects, may further include an indication of a reporting configuration, e.g., an indication of what to report and how to report it as discussed above. For example, referring to FIGS. 4, 5A-5D, 6, and 7, the base station 402a, 602b, or 702 may configure, via the first configuration 706A, the first set of resources (e.g., the second set of DL resources 524, the sub-bands 1, 2, 4, and 5 in diagram 650, the sub-bands 1-5 in diagram 660, or the DL resources in the resource allocation indicated by the configuration 706) for the first UE 404a, the third UE 604c, or the UE 704 to use to measure, at 708, a CLI metric in each of the plurality of DL sub-bands configured for the first UE. The CLI, in some aspects, may be from an UL transmission via one of the first set of UL resources 522 of the third diagram 520 or sub-band 3 of diagrams 650 and 660 and the CLI metric may be one or more of a RSRP, a RSSI, a RSRQ, a SINR, or other relevant metric associated with a DL sub-band.

In some aspects, the base station 402a, 602b, or 702 may further configure, via the second configuration 706B, a second set of resources for transmitting the UL transmission from the second network node (e.g., the second UE or the second BS). For example, configuring the second set of resources may be performed by CU processor 1712, DU processor 1732, RU processor 1742, transceiver(s) 1746, antenna(s) 1780, and/or sub-band CLI configuration component 199 of FIG. 17. The UL transmission, in some aspects, may be an SRS. In some aspects, the second set of resources may include any of a full bandwidth allocated for UL transmissions, a sub-band of the full bandwidth allocated for the UL transmissions, or a variable number of resource blocks within a set of resource blocks allocated for the UL transmissions. For example, referring to FIGS. 4, 5A-5D, 6, and 7, the base station 402a, 602b, or 702 may configure, via the second configuration 706B, the second set of resources (e.g., the set of the first set of UL resources 522, the sub-band 3 in diagrams 650 and 660, or the UL resources and/or the SRS resources in the resource allocation indicated by the configuration 706) for a second network node (e.g., the second UE 404b or 604b, or the network node 705) to use to transmit an UL transmission that may cause CLI at the first UE 404a, the third UE 604c, or the UE 704.

The first UE may measure CLI from the second network node based on the configuration and the base station may receive, at 1404, a single-bit indication reporting the CLI metric for at least one DL sub-band in the plurality of DL sub-bands. For example, 1404 may be performed by CU processor 1712, DU processor 1732, RU processor 1742, transceiver(s) 1746, antenna(s) 1780, and/or sub-band CLI configuration component 199 of FIG. 17. The single-bit indication reporting the CLI metric for the at least one DL sub-band in the plurality of DL sub-bands, in some aspects, may include an individual single-bit indication for each of the plurality of DL sub-bands configured for the first UE. In some aspects, each individual single-bit indication may indicate whether the CLI metric for a corresponding DL sub-band is above (or below) a threshold value. The single-bit indication reporting the CLI metric for at least one DL sub-band in the plurality of DL sub-bands may include one single bit indication that jointly indicates whether the CLI metric is below (or above) a threshold value for each of the plurality of DL sub-bands. For example, referring to FIG. 7, the base station 702 may receive, and the UE 704 may transmit, CLI measurement reporting 712 including a single-bit indication reporting the CLI metric for the at least one DL sub-band in the plurality of DL sub-bands as depicted in diagrams 740 and 750.

In some aspects, the single-bit indication reporting the CLI metric for the at least one DL sub-band in the plurality of DL sub-bands may be received via one or more of layer 1 or layer 2 signaling. The single-bit indication reporting the CLI metric for the at least one DL sub-band in the plurality of DL sub-bands, in some aspects, may be received based on one or more of periodic scheduling, aperiodic scheduling, semi-periodic scheduling, or a triggering event. The timing of the transmission of the single-bit indication reporting the CLI metric for the at least one DL sub-band in the plurality of DL sub-bands, in some aspects, may be indicated in the configuration of the first set of resources for measuring the CLI metric for each of the plurality of DL sub-bands.

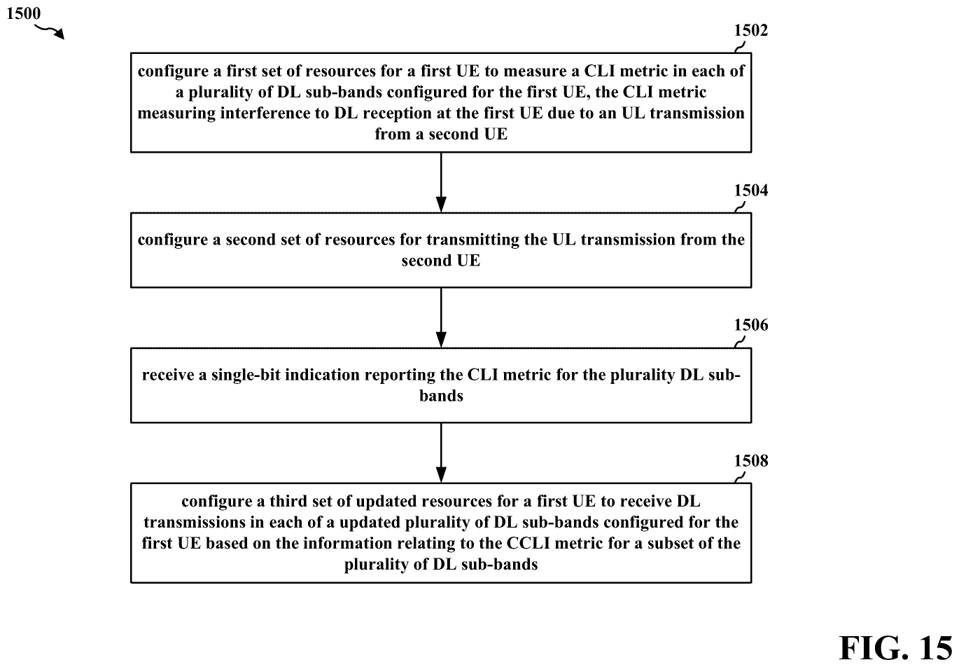

FIG. 15 is a flowchart 1500 of a method of wireless communication. The method may be performed by a network node, or base station, (e.g., the base station 102, 402a, 602b, or 702; the CU 110; the DU 130; the RU 140; the network node 1602; the network entity 1702). Aspects of the method may improve the reception of information from UEs for interference variations, including CLI experienced in particular sub-bands while also minimizing overhead for such CLI reports. The improved information may assist the network node in allocating resources for wireless communication.

At 1502, the base station may configure a first set of resources for a first UE to measure a CLI metric in each of a plurality of DL sub-bands configured for the first UE. In some aspects, the CLI metric measures interference to DL reception at the first UE due to an UL transmission from a second network node (e.g., a second UE or a second base station). For example, 1502 may be performed by CU processor 1712, DU processor 1732, RU processor 1742, transceiver(s) 1746, antenna(s) 1780, and/or sub-band CLI configuration component 199 of FIG. 17. In some aspects, configuring the first set of resources at 1502 may include transmitting an indication of the configured first set of resources to the first UE. The indication, in some aspects, may further include an indication of a reporting configuration, e.g., an indication of what to report and how to report it as discussed above. For example, referring to FIGS. 4, 5A-5D, 6, and 7, the base station 402a, 602b, or 702 may configure, via the first configuration 706A, the first set of resources (e.g., the second set of DL resources 524, the sub-bands 1, 2, 4, and 5 in diagram 650, the sub-bands 1-5 in diagram 660, or the DL resources in the resource allocation indicated by the configuration 706) for the first UE 404a, the third UE 604c, or the UE 704 to use to measure, at 708, a CLI metric in each of the plurality of DL sub-bands configured for the first UE. The CLI, in some aspects, may be from an UL transmission via one of the first set of UL resources 522 of the third diagram 520 or sub-band 3 of diagrams 650 and 660 and the CLI metric may be one or more of a RSRP, a RSSI, a RSRQ, a SINR, or other relevant metric associated with a DL sub-band.

At 1504, the base station may further configure, via a second configuration, a second set of resources for transmitting the UL transmission from the second network node (e.g., the second UE or the second BS). For example, 1504 may be performed by CU processor 1712, DU processor 1732, RU processor 1742, transceiver(s) 1746, antenna(s) 1780, and/or sub-band CLI configuration component 199 of FIG. 17. The UL transmission, in some aspects, may be an SRS. In some aspects, the second set of resources may include any of a full bandwidth allocated for UL transmissions, a sub-band of the full bandwidth allocated for the UL transmissions, or a variable number of resource blocks within a set of resource blocks allocated for the UL transmissions. For example, referring to FIGS. 4, 5A-5D, 6, and 7, the base station 402a, 602b, or 702 may configure, via the second configuration 706B, the second set of resources (e.g., the set of the first set of UL resources 522, the sub-band 3 in diagrams 650 and 660, or the UL resources and/or the SRS resources in the resource allocation indicated by the configuration 706) for a second network node (e.g., the second UE 404b or 604b, or the network node 705) to use to transmit an UL transmission that may cause CLI at the first UE 404a, the third UE 604c, or the UE 704.

The first UE may measure CLI from the second network node based on the configuration and the base station may receive, at 1506, a single-bit indication reporting the CLI metric for at least one DL sub-band in the plurality of DL sub-bands. For example, 1506 may be performed by CU processor 1712, DU processor 1732, RU processor 1742, transceiver(s) 1746, antenna(s) 1780, and/or sub-band CLI configuration component 199 of FIG. 17. The single-bit indication reporting the CLI metric for at least one DL sub-band in the plurality of DL sub-bands, in some aspects, may include an individual single-bit indication for each of the plurality of DL sub-bands configured for the first UE. In some aspects, each individual single-bit indication may indicate whether the CLI metric for a corresponding DL sub-band is above (or below) a threshold value. The single-bit indication reporting the CLI metric for at least one DL sub-band in the plurality of DL sub-bands may include one single bit indication that jointly indicates whether the CLI metric is below (or above) a threshold value for each of the plurality of DL sub-bands. For example, referring to FIG. 7, the base station 702 may receive, and the UE 704 may transmit, CLI measurement reporting 712 including a single-bit indication reporting the CLI metric for the at least one DL sub-band in the plurality of DL sub-bands as depicted in diagrams 740 and 750.

In some aspects, the single-bit indication reporting the CLI metric for the at least one DL sub-band in the plurality of DL sub-bands may be received via one or more of layer 1 or layer 2 signaling. The single-bit indication reporting the CLI metric for the at least one DL sub-band in the plurality of DL sub-bands, in some aspects, may be received based on one or more of periodic scheduling, aperiodic scheduling, semi-periodic scheduling, or a triggering event. The timing of the transmission of the single-bit indication reporting the CLI metric for the at least one DL sub-band in the plurality of DL sub-bands, in some aspects, may be indicated in the configuration of the first set of resources for measuring the CLI metric for each of the plurality of DL sub-bands.

Finally, at 1508, the base station may configure a third set of updated resources for a first UE to receive DL transmissions in each of an updated plurality of DL sub-bands configured for the first UE based on the in single-bit indication reporting the CLI metric for the at least one DL sub-band in the plurality of DL sub-bands. For example, 1508 may be performed by CU processor 1712, DU processor 1732, RU processor 1742, transceiver(s) 1746, antenna(s) 1780, and/or sub-band CLI configuration component 199 of FIG. 17. The base station may determine, based on the single-bit indication reporting the CLI metric for the at least one DL sub-band in the plurality of DL sub-bands received at 1506, an optimized (or improved) configuration of DL sub-band resources and UL sub-band resources to reduce CLI experienced by the first UE, by adjusting the location of the UL sub-band resource(s) in relation to the DL sub-band resource(s). In some aspects, the base station may optimize the data sent using the different sub-bands, e.g., using sub-bands experiencing high CLI to transmit low-priority data and using sub-bands experiencing low CLI to transmit higher-priority data. For example, referring to FIG. 7, the base station 702 may determine, at 714, an updated configuration based on the CLI measurement reporting 712 and may configure a third set of updated resources for the first UE to receive DL transmission in each of the updated plurality of DL sub-bands via the first updated configuration 716A transmitted to, and received by, the UE 704. The updated configuration 716 indicates, for example, that a location of an UL sub-band resource and a DL resource have been swapped in the updated configuration 716 when compared with the configuration 706.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network node 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., the UE 350 of FIG. 3) and include the additional modules of the apparatus 1604.

As discussed supra, the sub-band CLI report component 198 is configured to measure a CLI metric for each of a plurality of DL sub-bands configured for the first UE, the CLI metric measuring interference to DL reception at the first UE due to an UL transmission from a second UE and to transmit information relating to the CLI metric for a subset of the plurality of DL sub-bands. In some aspects, sub-band CLI report component 198 is configured to measure a CLI metric for each of a plurality of DL sub-bands configured for the first UE, the CLI metric measuring interference to DL reception at the first UE due to an UL transmission from a second UE and to transmit a single-bit indication reporting the CLI metric for at least one DL sub-band in the plurality of DL sub-bands. The sub-band CLI report component 198 may be within the cellular baseband processor 1624, the application processor 1606, or both the cellular baseband processor 1624 and the application processor 1606. The sub-band CLI report component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for measuring a CLI metric for each of a plurality of DL sub-bands configured for the first UE, the CLI metric measuring interference to DL reception at the first UE due to an UL transmission from a second UE; a means for transmitting information relating to the CLI metric for a subset of the plurality of DL sub-bands; means for transmitting a single-bit indication reporting the CLI metric for at least one DL sub-band in the plurality of DL sub-bands; and/or receiving a first indication of a configuration of a first set of resources for measuring the CLI metric for each of the plurality of DL sub-bands. The apparatus 1604 may include means to perform any of the aspects described in connection with FIG. 8, FIG. 9, FIG. 10, FIG. 11, and/or the aspects performed by the UE in FIG. 7. The means may be the sub-band CLI report component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 17 is a diagram 1700 illustrating an example of a hardware implementation for a network node, which may also be referred to as a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the sub-band CLI configuration component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the sub-band CLI configuration component 199 is configured to configure a first set of resources for a first UE to measure a CLI metric in each of a plurality of DL sub-bands configured for the first UE, the CLI metric measuring interference to DL reception at the first UE due to an UL transmission from a second UE and to receive information relating to the CLI metric for a subset of the plurality of DL sub-bands. In some aspects, the sub-band CLI configuration component 199 is configured to configure a first set of resources for a first UE to measure a CLI metric in each of a plurality of DL sub-bands configured for the first UE, the CLI metric measuring interference to DL reception at the first UE due to an UL transmission from a second UE and to receive a single-bit indication reporting the CLI metric for at least one DL sub-band in the plurality of DL sub-bands. The sub-band CLI configuration component 199 may be within one or more processors of one or more of the CU 1710, DU 1730, and the RU 1740. The sub-band CLI configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for configuring a first set of resources for a first UE to measure a CLI metric in each of a plurality of DL sub-bands configured for the first UE, the CLI metric measuring interference to DL reception at the first UE due to an UL transmission from a second UE; configuring a second set of resources for transmitting the UL transmission from the second UE; receiving information relating to the CLI metric for a subset of the plurality of DL sub-bands; and/or receiving a single-bit indication reporting the CLI metric for at least one DL sub-band in the plurality of DL sub-bands. The network entity 1702 may include means to perform any of the aspects described in connection with FIG. 12, FIG. 13, FIG. 14, FIG. 15, and/or the aspects performed by the base station or network node in FIG. 7. The means may be the sub-band CLI configuration component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, the ability to perform CLI measurements for each of a plurality of sub-bands may provide additional information that allows for better resource allocation between UL and DL resources (or better allocation of UL/DL resources among transmissions of different priorities). However, the sub-band reporting of CLI, in some aspects, increases signaling overhead. Accordingly, a method and apparatus for reducing the overhead associated with sub-band CLI reporting is presented. For example, the reported sub-band CLIs may be limited to those that are above a configured CLI threshold value or a single bit for each sub-band may be added to indicate whether the sub-band is experiencing CLI above (or below) a threshold instead of a multi-bit indication of a CLI metric value. In some aspects, the method and apparatus presented herein provide some of the benefits of per-sub-band CLI reporting while reducing the overhead costs of per-sub-band CLI reporting.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE, including measuring a CLI metric for each of a plurality of DL sub-bands configured for the first UE, the CLI metric measuring CLI to DL reception at the first UE due to an UL transmission from a second UE and transmitting information relating to the CLI metric for a subset of the plurality of DL sub-bands.

Aspect 2 is the method of aspect 1, where the subset of the plurality of DL sub-bands includes a first number of DL sub-bands for which a corresponding measured CLI is larger than the corresponding measured CLI for each DL sub-band in the plurality of DL sub-bands not included in the subset of the plurality of DL sub-bands.

Aspect 3 is the method of aspect 2, where the first number of DL sub-bands is equal to one and the subset of the plurality of DL sub-bands includes a DL sub-band with a largest corresponding measured CLI.

Aspect 4 is the method of aspect 2, where the first number of DL sub-bands is one of a second number configured based on one or more of a first indication from a network entity or a second indication transmitted by the first UE, or a third number of measured CLI values above a threshold value.

Aspect 5 is the method of aspect 1, where the information relating to the CLI metric for the subset of the plurality of DL sub-bands further includes a bitmap indicating DL sub-bands in the subset of the plurality of DL sub-bands.

Aspect 6 is the method of any of aspects 1-4, where the information relating to the CLI metric for the subset of the plurality of DL sub-bands includes a set of DL sub-band IDs, where the set of DL sub-band IDs indicates DL sub-bands in the subset of the plurality of DL sub-bands.

Aspect 7 is the method of any of aspects 1-6, further including receiving a first indication of a configuration of a first set of resources for measuring the CLI metric for each of the plurality of DL sub-bands.

Aspect 8 is the method of aspect 7, where the UL transmission is a sounding reference signal and a second set of resources configured for the UL transmission includes any of a full bandwidth allocated for UL transmissions, a sub-band of the full bandwidth allocated for the UL transmissions, or a variable number of resource blocks within a set of resource blocks allocated for the UL transmissions.

Aspect 9 is the method of any of aspects 1-8, where the information relating to the subset of the plurality of CLI metrics is transmitted via one or more of layer 1 or layer 2 signaling, and the information relating to the CLI metric for the subset of the plurality of DL sub-bands is transmitted based on one or more of periodic scheduling, aperiodic scheduling, semi-periodic scheduling, or a triggering event.

Aspect 10 is a method of wireless communication at a first UE, including measuring a CLI metric for each of a plurality of DL sub-bands configured for the first UE, the CLI metric measuring CLI to DL reception at the first UE due to an UL transmission from a second UE and transmitting a single-bit indication reporting the CLI metric for at least one DL sub-band in the plurality of DL sub-bands.

Aspect 11 is the method of aspect 10, where the single-bit indication reporting the CLI metric for the at least one DL sub-band in the plurality of DL sub-bands includes an individual single-bit indication for each of the plurality of DL sub-bands configured for the first UE, each individual single-bit indication indicating whether the CLI metric for a corresponding DL sub-band is above a threshold value.

Aspect 12 is the method of aspect 10, where the single-bit indication reporting the CLI metric for the at least one DL sub-band in the plurality of DL sub-bands includes one single bit indication that jointly indicates whether the CLI metric is below a threshold value for each of the plurality of DL sub-bands.

Aspect 13 is the method of any of aspects 10-12, further including receiving a first indication of a configuration of a first set of resources for measuring the CLI metric for each of the plurality of DL sub-bands.

Aspect 14 is the method of aspect 13, where the UL transmission is a sounding reference signal and a second set of resources configured for the UL transmission includes any of a full bandwidth allocated for UL transmissions, a sub-band of the full bandwidth allocated for the UL transmissions, or a variable number of resource blocks within a set of resource blocks allocated for the UL transmissions.

Aspect 15 is the method of any of aspects 10-14, where the single-bit indication reporting the CLI metric for the at least one DL sub-band in the plurality of DL sub-bands is transmitted via one or more of layer 1 or layer 2 signaling.

Aspect 16 is the method of any of aspects 10-15, where the single-bit indication reporting the CLI metric for the at least one DL sub-band in the plurality of DL sub-bands is transmitted based on one or more of periodic scheduling, aperiodic scheduling, semi-periodic scheduling, or a triggering event.

Aspect 17 is a method of wireless communication at a network node, including configuring a first set of resources for a first UE to measure a CLI metric in each of a plurality of DL sub-bands configured for the first UE, the CLI metric measuring CLI to DL reception at the first UE due to an UL transmission from a second UE and receiving information relating to the CLI metric for a subset of the plurality of DL sub-bands.

Aspect 18 is the method of aspect 17, where the subset of the plurality of DL sub-bands includes a first number of DL sub-bands for which a corresponding measured CLI is larger than the corresponding measured CLI for each DL sub-band in the plurality of DL sub-bands not included in the subset of the plurality of DL sub-bands.

Aspect 19 is the method of aspect 18, where the first number of DL sub-bands is equal to one and the subset of the plurality of DL sub-bands includes a DL sub-band with a largest corresponding measured CLI.

Aspect 20 is the method of aspect 18, where the first number of DL sub-bands is one of a second number configured based on one or more of a first indication from a network entity or a second indication transmitted by the first UE, or a third number of measured CLI values above a threshold value.

Aspect 21 is the method of aspect 17, where the information relating to the CLI metric for the subset of the plurality of DL sub-bands further includes a bitmap indicating DL sub-bands in the subset of the plurality of DL sub-bands.

Aspect 22 is the method of any of aspects 17-20, where the information relating to the CLI metric for the subset of the plurality of DL sub-bands includes a set of DL sub-band IDs, where the set of DL sub-band IDs indicates DL sub-bands in the subset of the plurality of DL sub-bands.

Aspect 23 is the method of any of aspects 17-22, further including configuring a second set of resources for transmitting the UL transmission from the second UE, where the UL transmission is a sounding reference signal and the second set of resources includes any of a full bandwidth allocated for UL transmissions, a sub-band of the full bandwidth allocated for the UL transmissions, or a variable number of resource blocks within a set of resource blocks allocated for the UL transmissions.

Aspect 24 is the method of any of aspects 17-23, where the information relating to the subset of the plurality of CLI metrics is received via one or more of layer 1 or layer 2 signaling, and the information relating to the CLI metric for the subset of the plurality of DL sub-bands is received based on one or more of periodic scheduling, aperiodic scheduling, semi-periodic scheduling, or a triggering event.

Aspect 25 is a method of wireless communication at a network node, including configuring a first set of resources for a first UE to measure a CLI metric in each of a plurality of DL sub-bands configured for the first UE, the CLI metric measuring CLI to DL reception at the first UE due to an UL transmission from a second UE and receiving a single-bit indication reporting the CLI metric for at least one DL sub-band in the plurality of DL sub-bands.

Aspect 26 is the method of aspect 25, where the single-bit indication reporting the CLI metric for the at least one DL sub-band in the plurality of DL sub-bands includes an individual single-bit indication for each of the plurality of DL sub-bands configured for the UE, each individual single-bit indication indicating whether the CLI metric for a corresponding DL sub-band is above a threshold value.

Aspect 27 is the method of aspect 25, where the single-bit indication reporting the CLI metric for the at least one DL sub-band in the plurality of DL sub-bands includes one single bit indication that jointly indicates whether the CLI metric is above a threshold value for each of the plurality of DL sub-bands.

Aspect 28 is the method of any of aspects 25-27, further including configuring a second set of resources for transmitting the UL transmission from the second UE, where the UL transmission is a sounding reference signal and the second set of resources includes any of a full bandwidth allocated for UL transmissions, a sub-band of the full bandwidth allocated for the UL transmissions, or a variable number of resource blocks within a set of resource blocks allocated for the UL transmissions.

Aspect 29 is the method of any of aspects 25-28, where the single-bit indication reporting the CLI metric for the at least one DL sub-band in the plurality of DL sub-bands is received via one or more of layer 1 or layer 2 signaling.

Aspect 30 is the method of any of aspects 25-29, where the single-bit indication reporting the CLI metric for the at least one DL sub-band in the plurality of DL sub-bands is received based on one or more of periodic scheduling, aperiodic scheduling, semi-periodic scheduling, or a triggering event.

Aspect 31 is an apparatus for wireless communication at a device including a memory and at least one processor coupled to the memory and, based at least in part on information stored in the memory, the at least one processor is configured to implement any of aspects 1 to 30.

Aspect 32 is the apparatus of aspect 31, further including a transceiver or an antenna coupled to the at least one processor.

Aspect 33 is an apparatus for wireless communication at a device including means for implementing any of aspects 1 to 30.

Aspect 34 is a computer-readable medium (e.g., a non-transitory computer-readable medium) storing computer executable code, where the code when executed by a processor causes the processor to implement any of aspects 1 to 30.

What is claimed is:

1. An apparatus for wireless communication at a first user equipment (UE), comprising:
memory; and
at least one processor coupled to the memory and, based at least in part on stored information that is stored in the memory, the at least one processor is configured to:
measure a cross link interference (CLI) metric for each of a plurality of downlink (DL) sub-bands configured for the first UE, the CLI metric measuring CLI to DL reception at the first UE due to an uplink (UL) transmission from a second UE; and
transmit information relating to the CLI metric for a subset of the plurality of DL sub-bands.

2. The apparatus of claim 1, wherein the subset of the plurality of DL sub-bands comprises a first number of DL sub-bands for which a corresponding measured CLI is larger than the corresponding measured CLI for each DL sub-band in the plurality of DL sub-bands not included in the subset of the plurality of DL sub-bands.

3. The apparatus of claim 2, wherein the first number of DL sub-bands is equal to one and the subset of the plurality of DL sub-bands comprises a DL sub-band with a largest corresponding measured CLI.

4. The apparatus of claim 2, wherein the first number of DL sub-bands is one of:
a second number configured based on one or more of a first indication from a network entity or a second indication transmitted by the first UE, or
a third number of measured CLI values above a threshold value.

5. The apparatus of claim 1, wherein the information relating to the CLI metric for the subset of the plurality of DL sub-bands further comprises a bitmap indicating DL sub-bands in the subset of the plurality of DL sub-bands.

6. The apparatus of claim 1, wherein the information relating to the CLI metric for the subset of the plurality of DL sub-bands comprises a set of DL sub-band identifiers (IDs), wherein the set of DL sub-band IDs indicates DL sub-bands in the subset of the plurality of DL sub-bands.

7. The apparatus of claim 1, the at least one processor further configured to:
receive a first indication of a configuration of a first set of resources for measuring the CLI metric for each of the plurality of DL sub-bands.

8. The apparatus of claim 7, wherein the UL transmission is a sounding reference signal and a second set of resources configured for the UL transmission comprises any of:
a full bandwidth allocated for UL transmissions,
a sub-band of the full bandwidth allocated for the UL transmissions, or
a variable number of resource blocks within a set of resource blocks allocated for the UL transmissions.

9. The apparatus of claim 1, further comprising:
at least one transceiver or at least one antenna coupled to the at least one processor, wherein, to receive the CLI, the at least one processor is configured to receive the CLI via the at least one transceiver or the at least one antenna coupled to the at least one processor, wherein, to transmit the information relating to the CLI metric for the subset of the plurality of DL sub-bands, the at least one processor is configured to transmit, via one or more of layer 1 or layer 2 signaling, the information relating to the CLI metric for the subset of the plurality of DL sub-bands based on one or more of periodic scheduling, aperiodic scheduling, semi-periodic scheduling, or a triggering event.

10. An apparatus for wireless communication at a first user equipment (UE), comprising:
memory; and
at least one processor coupled to the memory and, based at least in part on information stored in the memory, the at least one processor is configured to:
measure a cross link interference (CLI) metric for each of a plurality of a downlink (DL) sub-bands configured for the first UE, the CLI metric measuring CLI to downlink reception at the first UE due to an uplink (UL) transmission from a second UE; and
transmit a single-bit indication reporting the CLI metric for at least one DL sub-band in the plurality of DL sub-bands.

11. The apparatus of claim 10, wherein the single-bit indication reporting the CLI metric for the at least one DL sub-band in the plurality of DL sub-bands comprises an individual single-bit indication for each of the plurality of DL sub-bands configured for the first UE, each individual single-bit indication indicating whether the CLI metric for a corresponding DL sub-band is above a threshold value.

12. The apparatus of claim 10, wherein the single-bit indication reporting the CLI metric for the at least one DL sub-band in the plurality of DL sub-bands comprises one single bit indication that jointly indicates whether the CLI metric is below a threshold value for each of the plurality of DL sub-bands.

13. The apparatus of claim 10, the at least one processor further configured to:
receive a first indication of a configuration of a first set of resources for measuring the CLI metric for each of the plurality of DL sub-bands.

14. The apparatus of claim 13, wherein the UL transmission is a sounding reference signal and a second set of resources configured for the UL transmission comprises any of:
a full bandwidth allocated for UL transmissions,
a sub-band of the full bandwidth allocated for the UL transmissions, or
a variable number of resource blocks within a set of resource blocks allocated for the UL transmissions.

15. The apparatus of claim 10, wherein the single-bit indication reporting the CLI metric for the at least one DL sub-band in the plurality of DL sub-bands is transmitted via one or more of layer 1 or layer 2 signaling.

16. The apparatus of claim 10, further comprising:
at least one transceiver or at least one antenna coupled to the at least one processor, wherein, to receive the single-bit indication reporting the CLI metric for the at least one DL sub-band in the plurality of DL sub-bands, the at least one processor is configured to receive the single-bit indication reporting the CLI metric for the at least one DL sub-band in the plurality of DL sub-bands via the at least one transceiver or the at least one antenna coupled to the at least one processor, wherein, to transmit the single-bit indication reporting the CLI metric for the at least one DL sub-band in the plurality of DL sub-bands, the at least one processor is configured to transmit the single-bit indication reporting the CLI metric for the at least one DL sub-band in the plurality of DL sub-bands based on one or more of periodic scheduling, aperiodic scheduling, semi-periodic scheduling, or a triggering event.

17. An apparatus for wireless communication at a network node, comprising:
memory; and
at least one processor coupled to the memory and, based at least in part on stored information that is stored in the memory, the at least one processor is configured to:
configure a first set of resources for a first user equipment (UE) to measure a cross link interference (CLI) metric in each of a plurality of downlink (DL) sub-bands configured for the UE, the CLI metric measuring CLI to DL reception at the first UE due to an uplink (UL) transmission from a second UE; and
receive information relating to the CLI metric for a subset of the plurality of DL sub-bands.

18. The apparatus of claim 17, wherein the subset of the plurality of DL sub-bands comprises a first number of DL sub-bands for which a corresponding measured CLI is larger than the corresponding measured CLI for each DL sub-band in the plurality of DL sub-bands not included in the subset of the plurality of DL sub-bands.

19. The apparatus of claim 18, wherein the first number of DL sub-bands is equal to one and the subset of the plurality of DL sub-bands comprises a DL sub-band with a largest corresponding measured CLI.

20. The apparatus of claim 18, wherein the first number of DL sub-bands is one of:
a second number configured based on one or more of a first indication from a network entity or a second indication transmitted by the first UE, or
a third number of measured CLI values above a threshold value.

21. The apparatus of claim 17, wherein the information relating to the CLI metric for the subset of the plurality of DL sub-bands further comprises a bitmap indicating DL sub-bands in the subset of the plurality of DL sub-bands.

22. The apparatus of claim 17, wherein the information relating to the CLI metric for the subset of the plurality of DL sub-bands comprises a set of DL sub-band identifiers (IDs), wherein the set of DL sub-band IDs indicates DL sub-bands in the subset of the plurality of DL sub-bands.

23. The apparatus of claim 17, the at least one processor further configured to:
configure a second set of resources for transmitting the UL transmission from the second UE, wherein the UL transmission is a sounding reference signal and the second set of resources comprises any of:
a full bandwidth allocated for UL transmissions,
a sub-band of the full bandwidth allocated for the UL transmissions, or
a variable number of resource blocks within a set of resource blocks allocated for the UL transmissions.

24. The apparatus of claim 17, further comprising:
at least one transceiver or at least one antenna coupled to the at least one processor, wherein, to receive the information relating to the CLI metric for the subset of the plurality of DL sub-bands, the at least one processor is configured to receive, via one or more of layer 1 or layer 2 signaling, the information relating to the CLI metric for the subset of the plurality of DL sub-bands via the at least one transceiver or the at least one antenna coupled to the at least one processor based on one or more of periodic scheduling, aperiodic scheduling, semi-periodic scheduling, or a triggering event.

25. An apparatus for wireless communication at a network node, comprising:
memory; and
at least one processor coupled to the memory and, based at least in part on information stored in the memory, the at least one processor is configured to:
configure a first set of resources for a first user equipment (UE) to measure a cross link interference (CLI) metric in each of a plurality of downlink (DL) sub-bands configured for the first UE, the CLI metric measuring CLI to DL reception at the first UE due to an uplink (UL) transmission from a second UE; and
receive a single-bit indication reporting the CLI metric for at least one DL sub-band in the plurality of DL sub-bands.

26. The apparatus of claim 25, wherein the single-bit indication reporting the CLI metric for the at least one DL sub-band in the plurality of DL sub-bands comprises an individual single-bit indication for each of the plurality of DL sub-bands configured for the UE, each individual single-bit indication indicating whether the CLI metric for a corresponding DL sub-band is above a threshold value.

27. The apparatus of claim 25, wherein the single-bit indication reporting the CLI metric for the at least one DL sub-band in the plurality of DL sub-bands comprises one single bit indication that jointly indicates whether the CLI metric is above a threshold value for each of the plurality of DL sub-bands.

28. The apparatus of claim 25, the at least one processor further configured to:
configure a second set of resources for transmitting the UL transmission from the second UE, wherein the UL transmission is a sounding reference signal and the second set of resources comprises any of:
a full bandwidth allocated for UL transmissions,
a sub-band of the full bandwidth allocated for the UL transmissions, or
a variable number of resource blocks within a set of resource blocks allocated for the UL transmissions.

29. The apparatus of claim 25, wherein the single-bit indication reporting the CLI metric for the at least one DL sub-band in the plurality of DL sub-bands is transmitted via one or more of layer 1 or layer 2 signaling.

30. The apparatus of claim 25, further comprising:
at least one transceiver or at least one antenna coupled to the at least one processor, wherein, to receive the single-bit indication reporting the CLI metric for the at least one DL sub-band in the plurality of DL sub-bands, the at least one processor is configured to receive the single-bit indication reporting the CLI metric for the at least one DL sub-band in the plurality of DL sub-bands based on one or more of periodic scheduling, aperiodic scheduling, semi-periodic scheduling, or a triggering event.
